(19) United States
(12) Patent Application Publication
(10) Pub. No.: US 2021/0256481 A1
(43) Pub. Date: Aug. 19, 2021

(54) RESOURCE RESERVATION SYSTEM, USAGE MANAGEMENT METHOD, AND NON-TRANSITORY RECORDING MEDIUM

(71) Applicants: RYO SUZUKI, KANAGAWA (JP); NATSUMI FUJIMURA, KANAGAWA (JP)

(72) Inventors: RYO SUZUKI, KANAGAWA (JP); NATSUMI FUJIMURA, KANAGAWA (JP)

(73) Assignee: Ricoh Company, Ltd., Tokyo (JP)

(21) Appl. No.: 17/151,964

(22) Filed: Jan. 19, 2021

(30) Foreign Application Priority Data
Feb. 13, 2020 (JP) 2020-022678

(51) Int. Cl. G06Q 10/10; G06Q 10/02; G06Q 10/06

(52) U.S. Cl. CPC G06Q 10/1095; G06Q 10/06314; G06Q 10/02

(57) ABSTRACT

A resource reservation system, a usage management method, and a non-transitory recording medium. The resource reservation system acquires resource identification information of each resource that is accessible and requests the information processing apparatus to use the resource identified by the acquired resource identification information.

### CROSS-REFERENCE TO RELATED APPLICATIONS

This patent application is based on and claims priority pursuant to 35 U.S.C. § 119(a) to Japanese Patent Application No. 2020-022678, filed on Feb. 13, 2020, in the Japan Patent Office, the entire disclosure of which is hereby incorporated by reference herein.

### BACKGROUND

### Technical Field

The present disclosure relates to a resource reservation system, a usage management method, and a non-transitory recording medium.

### Background Art

A technique in which an information processing terminal provided in a meeting room displays information related to reservation of resources such as the meeting room is known. When a user starts using the meeting room, a start of use is input to the information processing terminal, and when the user ends the use, an end of use is input.

A technique for improving convenience when using the meeting room reserved by the user has been disclosed. In the known meeting room reservation system, a management server and a terminal device provided in front of the meeting room are connected via a communication network and the user holds an integrated circuit (IC) card over an IC card reader included in the terminal device in front of the meeting room to be authenticated at the start of use of the meeting room.

### SUMMARY

Embodiments of the present disclosure describe a resource reservation system, a usage management method, and a non-transitory recording medium. The resource reservation system acquires resource identification information of each resource that is accessible and requests the information processing apparatus to use the resource identified by the acquired resource identification information.

### BRIEF DESCRIPTION OF THE DRAWINGS

A more complete appreciation of the embodiments and many of the attendant advantages and features thereof can be readily obtained and understood from the following detailed description with reference to the accompanying drawings, wherein:

FIG. 1 is a diagram illustrating an overview of operation performed by a resource reservation system, according to embodiments of the present disclosure;

FIG. 2 is a diagram illustrating an outline of the overall operation of a resource reservation system when a meeting room terminal is not provided in the meeting room;

FIG. 3 is a schematic diagram illustrating an example of a system configuration of the resource reservation system, according to embodiments of the present disclosure;

FIG. 4 is a diagram illustrating a hardware configuration of an example of a computer system;

FIG. 5 is a diagram illustrating an example of a hardware configuration of the meeting room terminal or a terminal device;

FIGS. 6A and 6B are block diagrams illustrating functional configurations of a reservation management server, a chat server, a meeting management server, and a registration terminal according to embodiments of the present disclosure;

FIGS. 7A and 7B are block diagrams illustrating functional configurations of the terminal device and the meeting room terminal according to embodiments of the present disclosure;

FIG. 8 is a sequence diagram illustrating an operation of the resource reservation system;

FIG. 9 is a diagram illustrating reservation information stored in the meeting management, information database (DB) by the meeting management server;

FIG. 10 is a diagram illustrating a reservation information screen in which the same user as a reservation-making user displays the reservation information of FIG. 9;

FIG. 11 is a diagram illustrating the reservation information screen in which a user different from the reservation-making user or a participant account displays the reservation information of FIG. 9;

FIG. 12 is a diagram illustrating the reservation information screen in which a user displays the reservation information of FIG. 9 when the meeting room is not reserved;

FIG. 13 is a diagram illustrating an example of the reservation information screen displayed by the terminal device when “use now” button is pressed;

FIG. 14 is a flowchart illustrating an example of a process executed by a meeting management server;

FIG. 15 is a flowchart illustrating an example of a process in which a terminal device displays the reservation information;

FIG. 16 is a sequence diagram illustrating an operation of the resource reservation system according to a second embodiment of the present disclosure;

FIG. 17 is a diagram illustrating an example of the reservation information stored in the meeting management information DB by the meeting management server;

FIG. 18 is a diagram illustrating an example of the reservation information screen of meeting room 201 displayed on the terminal device by Mr. A;

FIG. 19 is a diagram illustrating an example of the reservation information screen of the meeting room 201 displayed on the terminal device by Mr. B;

FIG. 20 is a diagram illustrating an example of the reservation information screen of the meeting room 201 displayed on the terminal device by Mr. C;

FIG. 21 is a diagram illustrating an example of the reservation information screen of the meeting room 201 displayed by the terminal device when Mr. A captured an image code at 13:00;

FIG. 22 is a diagram illustrating an example of the reservation information screen of another meeting room transitioned from the reservation information screen of FIG. 19;

FIG. 23 is a diagram illustrating an example of a new reservation screen transitioned from the reservation information screen of FIG. 18;

FIG. 24 is a diagram illustrating an example of meeting room arrangement information;

FIG. 25 is a diagram illustrating an example of a new reservation screen for displaying a plurality of meeting rooms in a selectable manner;

FIG. 26 is a flowchart illustrating an example of a process executed by the meeting management server;

FIG. 27 is a flowchart illustrating an example of a process in which a terminal device displays the reservation information; and

FIG. 28 is a diagram illustrating an example of an outline of the overall operation of the resource reservation system according to a third embodiment of the present disclosure.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result. As used herein, the singular forms “a”, “an”, and “the” are intended to include the plural forms as well, unless the context clearly indicates otherwise.

Hereinafter, a description is given of a resource reservation system and a usage management method executed by the resource reservation system, according to embodiments of the present disclosure.

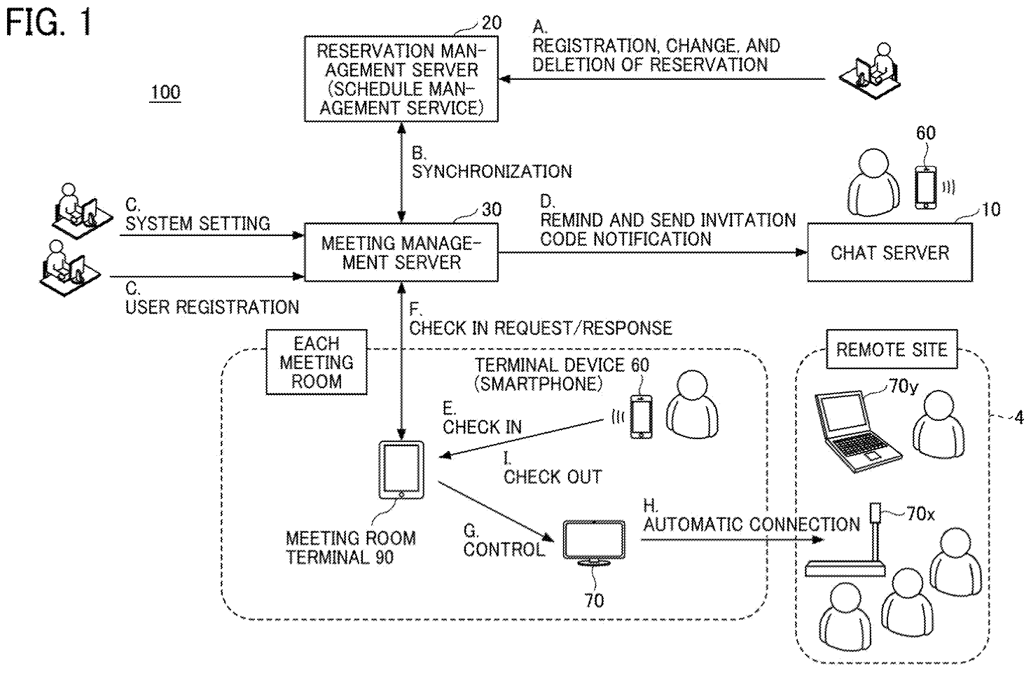

The outline of the resource reservation system 100 is described with reference to FIG. 1. FIG. 1 is a diagram illustrating an overview of operation performed by a resource reservation system 100, according to the present disclosure. Here, a case where a meeting room terminal (an example of an information processing terminal) is provided in a meeting room is described for reference.

A. A reservation-making user (the user who makes reservation) operates a terminal device 60 to communicate with a reservation management server 20 in order to reserve a meeting room. The reservation management server 20 is a general-purpose cloud service such as Office365 (registered trademark) and G Suite (registered trademark) and a meeting room owned by an organization such as a company to which the reservation-making user belongs is registered.

B. A meeting management server 30 is a server that controls entire operation of the resource reservation system 100 based on the reservation status of the meeting rooms. The meeting management server 30 communicates with the reservation management server 20 at suitable timings to acquire reservation information, in order to synchronize the reservation information between the meeting management server 30 and the reservation management server 20.

C. An administrator or the like of the organization or the resource reservation system 100 registers users and configures various settings to the meeting management server 30. For example, the user registration refers to registering a user to whom various notifications are to be sent by a chat server 10 such as Slack (registered trademark), Line (registered trademark), and Microsoft Teams (registered trademark). Further, since the notifications are sent by a bot that transmits a message as the meeting management server 30, the bot provided by the chat server 10 is also registered. Examples of the various settings configured by the administrator or the like to the meeting management server 30 include registration of a meeting room terminal 90 (initial setting described below) and a setting of a timing when a reminder is to be sent.

D. When the current time is a predetermined time period before the start time of a meeting defined in the reservation information, the meeting management server 30 sends a reminder of the scheduled meeting to the reservation-making user, thereby reducing an empty reservation of a meeting room. The “empty reservation” refers to reserving resources such as a meeting room that is not actually used. Further, the meeting management server 30 sends a notification indicating an invitation code to the user as needed. In response to receiving the reminder, the reservation-making user stores information (meeting identification information) for checking in the meeting room in the terminal device 60. Check-in refers to notifying the meeting management server 30 of the start of use of the meeting room and obtaining permission.

E. A meeting room terminal 90 is provided in each meeting room 6, and the meeting room terminal 90 downloads reservation information for a meeting held in the meeting room on a regular basis. The meeting room terminal 90 displays schedule of meetings to be held on the current day or the schedule of the upcoming meeting, thereby allowing participants of the meeting to confirm the schedule. The reservation-making user for the meeting room enters the meeting room 6 a little before the start time of the meeting to check-in. For example, the meeting identification information is input to the meeting room terminal 90, or the terminal device 60 is held over the meeting identification information (the meeting identification information is read, communicated, etc.).

F. The meeting room terminal 90 transmits the check-in request to the meeting management server 30, and if the meeting room terminal 90 is authenticated with the meeting identification information, the meeting room terminal 90 receives a response indicating that the check-in has succeeded from the meeting management server 30. The meeting room terminal 90 displays that the meeting room is in use (in session). In a case where the meeting management server 30 does not confirm a use start notification indicating the check-in by a preset time before or after the start time of the meeting, the meeting management server 30 automatically cancels the reservation of the meeting room 6. In other words, the meeting management server 30 cancels the reservation information when the use of the meeting room is not started for a preset time period. Further, the meeting management server 30 transmits, to the meeting room terminal 90, information indicating the reservation is canceled as status included in the reservation information. In this case, since the meeting room terminal 90 displays information indicating that the meeting room is vacant, any user can use the meeting room 6.

G. The meeting room terminal 90 controls an electronic device 70 in response to a request from the meeting management server 30. For example, the meeting room terminal 90 controls the electronic device 70 so that the power is turned on at the start time of the meeting and turned off at the end time of the meeting, thereby improving convenience when the meeting participant operates the electronic device 70.

H. When the electronic device 70 includes, for example, a videoconferencing function, the electronic device 70 communicates with an electronic device such as a videoconferencing terminal 70x at a remote site 4 to conduct a meeting (video conference). Note that a personal computer (PC) 70y on which an application operates can also communicate with the electronic device 70. The reservation information includes destination information (communication identifier (ID) of a communication destination) indicating the remote site 4 in advance. The electronic device 70 automatically communicates with the videoconferencing terminal 70x and the PC 70y by using the destination information.

I. When the reservation-making user ends the meeting, the user presses a button of the meeting room terminal 90 to check out. The meeting room terminal 90 displays the next reservation status, thereby allowing any user to check the reservation status of the meeting room. Check-out refers to notifying the meeting management server 30 of the end of use of the meeting room.

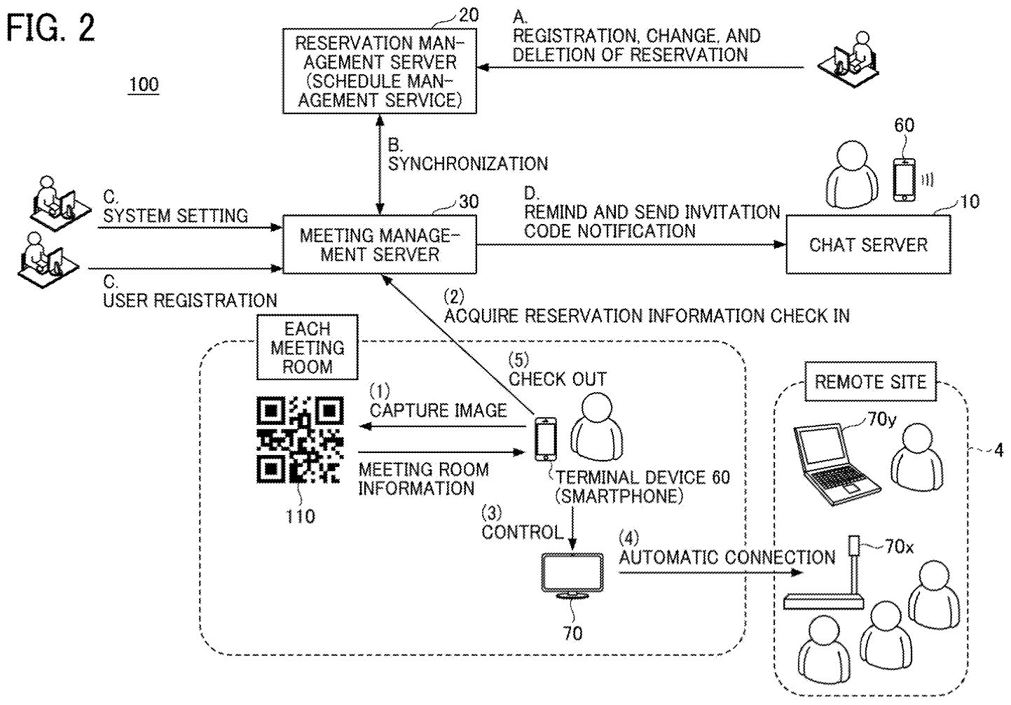

FIG. 2 is a diagram illustrating an outline of the overall operation of a resource reservation system when a meeting room terminal is not provided in the meeting room. The process from A to D may be the same as in FIG. 1.

(1) The user arrives at the meeting room to use the meeting room. An image code such as a Quick Response (QR) code (registered trademark) is presented (pasted) in the meeting room in advance. The meeting room information (meeting room ID, authentication key, email address) is encoded in the image code. The image code is presented for each resource and can be acquired for each resource. When the user captures the image code on the terminal device 60 on which a predetermined application operates, the meeting room information is decoded.

(2) The user is authenticated by the meeting management server 30 through the terminal device 60. The user is not required to enter the meeting identification information since the user has been authenticated. The terminal device 60 designates the meeting room ID acquired from the image code and starts communication with the meeting management server 30. The terminal device 60 can display, check-in, and make a reservation for the meeting room in which the image code is presented.

More specifically, the meeting management server 30 sorts into three cases which are,

(i) when the user is one of the reservation-making user and a participant included in the reservation information and the meeting room is “waiting for check-in”,

(ii) when the user is not the reservation-making user nor a participant included in the reservation information,

(iii) when there is no schedule at the current time, and in case of (i), performs check-in process.

(3) The internet protocol (IP) address of the electronic device 70 is registered in the meeting management server 30 in advance, and the meeting management server 30 transmits the IP address of the electronic device 70 to the terminal device 60 in response to a check-in request or the like. The terminal device 60 controls the electronic device 70 in the same manner as the meeting room terminal 90.

(4) When the electronic device 70 has, for example, a video meeting function, the electronic device 70 communicates with an electronic device (video meeting terminal 70x, etc.) of the remote site 4 and holds a meeting with the remote site 4.

(5) When the user ends the meeting, the user presses a predetermined button displayed on the terminal device 60 to check out. The terminal device 60 designates the meeting room information and requests the meeting management server 30 to check out. As a result, the meeting management server 30 detects the checkout, and the next user can use the meeting room.

As described above, a service providing system of the present embodiment can acquire the meeting room information by capturing the image code with the terminal device 60. Since the terminal device 60 can display the reservation information and perform check-in and check-out to the meeting management server 30, the meeting room terminal is not required for each meeting room. Since the meeting room terminal is not required for the meeting room, the burden of system construction and management operation can be reduced.

Further, since the meeting room can be used by the terminal device 60 that has been authenticated by the user, the user identification information and the reservation information that identifies the user can be stored and utilized. For example, the reservation information for each user can be shared to inform a boss or a colleague who is associated with the user's identification information about who is where and when. Further, in such case, the meeting management server of the present embodiment masks the reservation information displayed by the terminal device 60 according to the user's identification information, as described below. The meeting management server 30 sorts into two cases which are,

(i) reservation information including one of the reservation-making user and a participant and

(ii) other reservation information and

in case of (ii), masks the contents of the meeting and personal information among the reservation information.

As a result, it is possible to prevent an unspecified number of people from seeing the reservation information (meeting name, reservation-making user name, participant name) of the meeting room.

A resource refers to the resource owned, rented, or managed by an organization or the like. Organizational resources include, for example, meeting rooms, equipment, apparatuses, people (groups), company cars, bicycles, parking lots and bicycle parking lots, free addresses, desks, booths, remote meeting systems, printing services, and mechanisms. The resources that are difficult to move are called equipment. In the present embodiment, for the sake of explanatory convenience, the term “meeting room” is used as an example of the resource. In addition, as examples of resources outside the organization, various electronic devices, parking lots, rental offices, rental studios, rental cycles, rental cars (sharing cars), accommodation facilities such as hotels, various facilities such as entertainment venues, rental lockers, and rental spaces can be included.

Requesting the use of a resource according to the resource identification information may be a request for using the resource that requires the resource identification information. For example, a start of use or a start of reservation.

The reservation-making user is the person who reserved the meeting room, and the participant is a participant in the meeting. The reservation-making user is often included in the participants but may not be included. Persons who use the meeting room are simply called users.

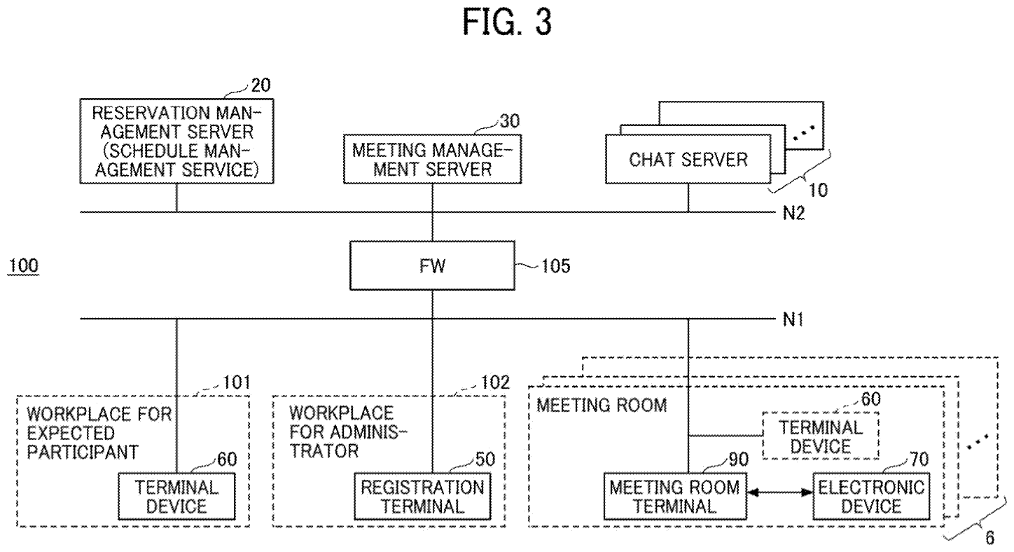

FIG. 3 is a schematic diagram illustrating an example of a system configuration of the resource reservation system 100, according to the present disclosure. The resource reservation system 100 is divided into an external network N2 and an intra-company network N1. The internal network N1 refers to a network inside a firewall 105, and the external network N2 is a network such as the internet through which unspecified volume of communication is transmitted.

The reservation management server 20, the meeting management server 30, and one or more chat servers 10 are connected to the external network N2. The servers communicate with one another as needed. The terminal device 60 operated by the participant of the meeting may be connected to the external network N2 as needed.

The reservation management server 20 is implemented by one or more information processing apparatuses (a computer system), each being installed with a general-purpose server operating system (OS) or the like. A system relating to the reservation of a resource, which system is provided by the reservation management server 20, is referred to as a reservation management system. The reservation management server 20 has a calendar system and provides a web application for managing various schedules. Specifically, the web application provides the following functions, for example.
To accept schedule registration and enable the reservation-making user to confirm the reservation from anywhere at any time.
To send a reminder email at the preset date and time, such as 30 minutes before the scheduled time.
To enable one person to manage schedules using plural calendars (for business, for private, etc.).
To share a calendar with users belonging to the same group.

The reservation management server 20 manages a user using an account. The account refers to a right for a user to use a service. In many systems, the user logs in to a system using the account. For this reason, the account has a function (function of identification information) to enable the system to uniquely identify the user. In the present embodiment, the reservation management server 20 transmits reservation information of the account (domain) registered in advance to the meeting management server 30. Alternatively, the meeting management server 30 requests the reservation information by designating the account of the reservation management server 20, to acquire the reservation information of the meeting room 6 from the reservation management server 20. The account can be any suitable information based on which a user can be uniquely identified. Examples of the account include an email address, an ID, and a telephone number.

Although in the present embodiment, the reservation management server 20 manages the reservation of each meeting room 6 as a schedule, the reservation management server 20 is configured to manage reservation information of various types of schedules in addition to the reservation of each meeting room 6. Although G Suite (registered trademark), Office 365 (registered trademark), and the like are known as reservation management systems, any other suitable reservation management system having functions described in the present embodiment will suffice.

Further, in the present embodiment, information relating to the one or more meeting rooms 6 within the intra-company network N1 is registered in advance with the reservation management server 20. In other words, the web application of the reservation management server 20 is customized according to a meeting room name, a meeting room ID, a reservation available time, a capacity, a unit of reservation and the like of each meeting room 6 residing within the intra-company network N1 of a company using the resource reservation system 100. Accordingly, each meeting room 6 of the company using the resource reservation system 100 is associated with the reservation information.

The chat server 10 is implemented by one or more information processing apparatuses (computer system), each being installed with a general-purpose server OS or the like. A system for real-time sharing of information such as text, audio and video by a plurality of users provided by the chat server 10 is referred to as a chat system. The chat server 10 notifies the terminal device 60 of the information about the reservation of the meeting room 6. In the present embodiment, the resource reservation system 100 can include a plurality of chat servers 10 operated by different entities respectively.

The information shared in the chat system includes image data, audio data, etc., in addition to text. In the present embodiment, a description is given of an example in which text is mainly used for the notification, for the sake of explanatory convenience. For example, the chat system can provide a voice chat capability for the group. The voice chat can be an one-to-one voice chat or an one-to-N voice chat, where N is two or more. In other words, according to the present embodiment, the chat system notifies the information about the reservation of the meeting room 6 by outputting a voice message, in addition to or in alterative to, displaying text. LINE (registered trademark), Slack (registered trademark), Microsoft Teams (registered trademark) and the like are known as chat systems, but any chat system having a capability of transmitting notification to one or a plurality of users from a bot (a program that executes predetermined processes) will suffice.

The chat server 10 also manages a user by using an account, which is different from the account of the reservation management server 20. The meeting management server 30 basically does not need to recognize the account of the chat server 10. However, the meeting management server 30 can transmit a notification by designating a desired account of the chat server 10.

The meeting management server 30 is implemented by one or more information processing apparatuses (computer system), each including a general-purpose server OS or the like. As a process relating to the external network N2, the meeting management server 30 acquires the reservation information of the meeting room 6 from the reservation management server 20. Further, the meeting management server 30 acquires an expected participant set in the reservation information and transmits a notification to the group of the chat server 10 (or to an individual user such as a reservation-making user) associated with the acquired expected participant at a preset time. As a process relating to the intra-company network N1, the meeting management server 30 manages a check-in and a check-out to and from the meeting room 6. Further, the meeting management server 30 controls turning on or off of the electronic device 70, based on the reservation information of the meeting room 6 acquired from the reservation management server 20.

An expected participant can access the external network N2 through the intra-company network N1 from various locations such as the meeting room 6, a workplace 101 for an expected participant, a workplace 102 for an administrator, and the like using the terminal device 60 in the intra-company network N1. Examples of the intra-company network N1 include a local area network (LAN). The meeting room 6, the workplace 101 for an expected participant, and the workplace 102 for an administrator are not necessarily in a LAN of the same company. When the terminal device 60 is a mobile phone or a smartphone, the external network N2 may be accessed through a telephone line and connected to the reservation management server 20, the meeting management server 30, and the chat server 10. In this case, the user of the terminal device 60 can connect to the external network N2 (internet connection) even if the user is not in the company.

In the meeting room 6, the meeting room terminal 90 and the electronic device 70 are located. In the present embodiment, a method of using a meeting room in which the meeting room terminal 90 is not provided is described. As described with reference to FIG. 2, depending on the meeting room (resource), the meeting room is used by using the terminal device 60 carried by each user instead of the meeting room terminal 90. The system may be capable of both using resources by the meeting room terminal 90 (resource terminal) and using resources by the terminal device 60 carried by each user.

The meeting room terminal 90 and the electronic device 70 can communicate with each other through a small-scale LAN or a dedicated line. The electronic device 70 can connect to the intra-company network N1 and the external network N2 without intervening the meeting room terminal 90. The meeting room terminal 90 and the electronic device 70 can communicate with each other either wirelessly or by wire. Since the intra-company network N1 is inside the firewall 105, it is difficult to perform direct communication from the external network N2 to the intra-company network N1.

The meeting room terminal 90 is an information processing terminal operated by a meeting participant who uses the meeting room 6, such as the reservation-making user of the meeting. The meeting room terminal 90 is a reception terminal that receives the use of the meeting room. For example, the meeting room terminal 90 is provided on a desk in the meeting room 6 or at an entrance of the meeting room 6. A plurality of the meeting room terminals 90 may be provided in one meeting room 6. The meeting room terminal 90 is implemented by one or more information processing apparatuses (computer systems), each being installed with a general-purpose OS or the like.

For example, the meeting room terminal 90 transmits the meeting room ID to the meeting management server 30, to display the reservation information of the meeting room 6 of the current day. Furthermore, the meeting room terminal 90 acquires control information such as turning on or off of the electronic device 70 from the meeting management server 30. The meeting room terminal 90 turns on or off the electronic device 70 using the acquired control information.

The meeting room terminal 90 displays a standby screen for receiving an instruction for check-in, check-out, etc. Further, the meeting room terminal 90 communicates with the meeting management server 30, to notify the meeting management server 30 of the check-in or the check-out. In response to receiving the instruction for check-in, the meeting room terminal 90 transmits, to the meeting management server 30, meeting identification information that is input by the reservation-making user and a meeting room ID that the meeting room terminal 90 holds in advance. Based on the meeting identification information and the meeting room ID transmitted from the meeting room terminal 90, the meeting management server 30 confirms that the reservation-making user of the meeting room 6 uses the reserved meeting room 6.

The electronic device 70 is various office devices that can be used in the meeting room 6. Examples of the electronic device 70 include an electronic whiteboard, a multifunction peripheral, a projector, a digital signage, and a digital camera. The electronic whiteboard includes a large-sized display that supports a touch panel system. The electronic whiteboard detects coordinates of a point pointed by the user on a board surface and displays a stroke by connecting the coordinates of the points. In addition, the electronic whiteboard is configured to display an image in accordance with data output from a PC that is connected to the electronic whiteboard. Further, the electronic whiteboard is configured to communicate with other electronic whiteboard located in a remote site to share the displayed stroke in a synchronous manner. The electronic whiteboard may be referred to as an electronic information board, etc.

The multifunction peripheral has multiple functions, such as a copier function, a scanner function, a printer function, and/or a facsimile transmitting/receiving function. The multifunction peripheral is used for printing or copying documents, scanning documents for conversion to digital data, and faxing documents during the meeting. The projector is a device that projects an image. For example, the projector projects an image (still image or moving image) displayed on a display of the terminal device 60 onto a screen, etc., to enable the participants to share the image. The digital signage is a large-sized display and is used for displaying any still images or moving images. The digital camera is used by each participant to capture an image formed on paper documents or presentation materials displayed on the electronic whiteboard for storage.

The terminal device 60 that is configured to connect to the intra-company network N1 is provided in the workplace 101 for an expected participant. The terminal device 60 may communicate by wire or wirelessly. The terminal device 60 is an information processing apparatus used when an expected participant (including a reservation-making user) reserves a meeting room. The expected participant (including the reservation-making user) may also use the terminal device 60 in the meeting room. In other words, the terminal device 60 is an information processing apparatus carried by the expected participant.

The terminal device 60 is implemented by one or more information processing apparatuses (computer system), each being installed with a general-purpose OS or the like. Examples of the terminal device 60 include a smartphone, a tablet terminal, a PC, a personal digital assistant (PDA), a wearable PC such as smart glasses and a smartwatch. Further, the terminal device 60 may be any suitable device, terminal or apparatus, provided that the device, terminal or apparatus has a communication capability and browser software, or application software dedicated to the chat server 10 or the reservation management server 20 operates on the device, terminal or apparatus. For example, the terminal device 60 may be a car navigation system, a game machine, a television receiver, and the like.

In the terminal device 60, application software dedicated to the chat server 10 and application software dedicated to the resource reservation system 100 operate. The application software dedicated to the chat server 10 is referred to as a “chat application” hereinafter. The application software dedicated to the resource reservation system 100 is referred to as a “meeting application” hereinafter. Browser software may be substituted for either one or both of the chat application and the meeting application.

The registration terminal 50 configured to connect to the intra-company network N1 is provided in the workplace 102 for administrator. The registration terminal 50 may communicate by wire or wirelessly. The registration terminal 50 is a display terminal for the administrator to make initial settings in the meeting room terminal 90.

The registration terminal 50 is implemented by the similar or substantially the similar information processing apparatus(es) that is implemented as the terminal device 60. However, since the registration terminal 50 is used mainly by an administrator for configuring settings to the meeting management server 30, the chat application and the meeting application can be omitted from the registration terminal 50. The registration terminal 50 communicates with the meeting management server 30 mainly by browser software and displays a web page.

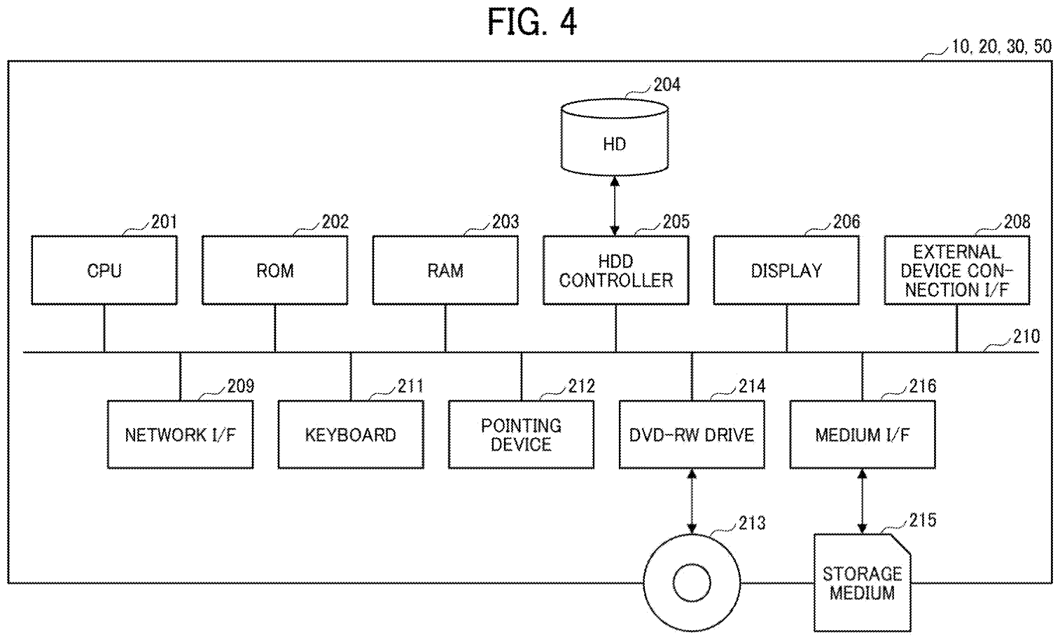

The meeting management server 30, the reservation management server 20, the chat server 10, and the registration terminal 50 are implemented by, for example, a computer system having a hardware configuration illustrated in FIG. 4. FIG. 4 is a diagram illustrating a hardware configuration of an example of the computer system according to the present embodiment.

As illustrated in FIG. 4, the computer system is implemented by a computer, and includes a central processing unit (CPU) 201, a read only memory (ROM) 202, a random access memory (RAM) 203, a hard disk (HD) 204, a hard disk drive (HDD) controller 205, a display 206, an external device connection interface (I/F) 208, a network I/F 209, a bus line 210, a keyboard 211, a pointing device 212, a digital versatile disc rewritable (DVD-RW) drive 214, and a medium I/F 216.

Among these elements, the CPU 201 controls entire operation of the computer system. The ROM 202 stores a program used for driving the CPU 201 such as an initial program loader (IPL). The RAM 203 is used as a work area for the CPU 201. The HD 204 stores various data such as a control program. The HDD controller 205 controls reading and writing of various data from and to the HD 204 under control of the CPU 201. The display 206 displays various information such as a cursor, menu, window, character, or image. The external device connection I/F 208 is an interface for connecting various external devices. The external device in this case is, for example, a universal serial bus (USB) memory or a printer. The network I/F 209 is an interface that controls communication of data through a communication network. The bus line 210 is an address bus, a data bus or the like, which electrically connects the elements in FIG. 4 such as the CPU 201.

The keyboard 211 is an example of an input device provided with a plurality of keys for allowing a user to input characters, numerals, or various instructions. The pointing device 212 is an example of an input device that allows a user to select or execute a specific instruction, select a target for processing, or move a cursor being displayed. The DVD-RW drive 214 reads and writes various data from and to a DVD-RW 213, which is an example of a removable storage medium. The removable storage medium is not limited to the DVD-RW and may be a digital versatile disc-recordable (DVD-R) or the like. The medium I/F 216 controls reading and writing (storing) of data from and to the storage medium 215 such as a flash memory.

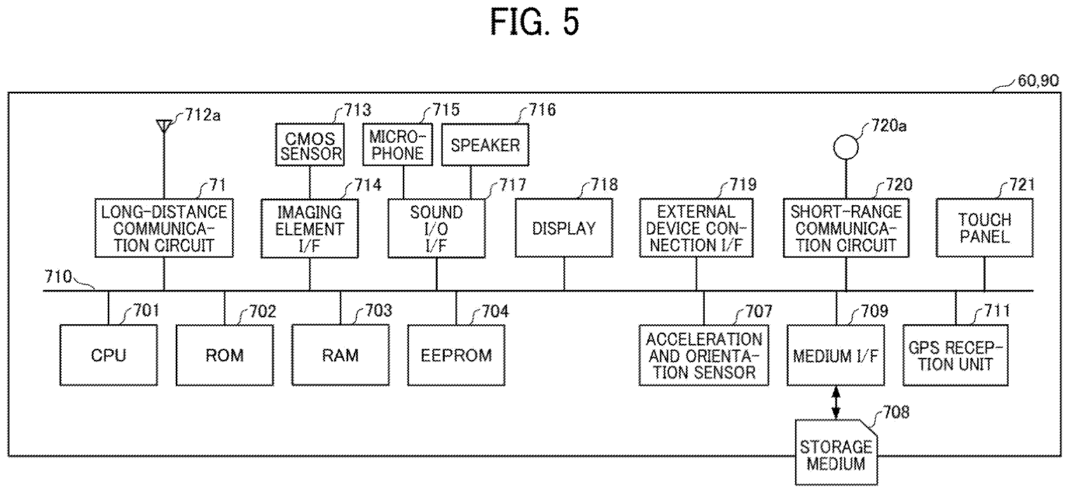

FIG. 5 is a diagram illustrating an example of a hardware configuration of the meeting room terminal 90 or a terminal device 60. The meeting room terminal 90 or the terminal device 60 in FIG. 5 is assumed to be a tablet device or a smartphone.

The meeting room terminal 90 or the terminal device 60 includes a CPU 701, a ROM 702, a RAM 703, an electrically erasable and programmable ROM (EEPROM) 704, an acceleration and orientation sensor 707, a medium I/F 709, and a global positioning system (GPS) reception unit 711.

The CPU 701 controls the overall operation of the meeting room terminal 90 or the terminal device 60. The ROM 702 stores programs used for driving the CPU 701 such as an initial program loader (IPL). The RAM 703 is used as a work area for the CPU 701. The EEPROM 704 reads or writes various data such as an application under control of the CPU 701. Example of the acceleration and orientation sensor 707 includes an electromagnetic compass or gyrocompass for detecting geomagnetism and an acceleration sensor. The medium I/F 709 controls reading and writing (storing) of data from and to the storage medium 708 such as a flash memory. The GPS reception unit 711 receives a GPS signal from a GPS satellite.

Further, the meeting room terminal 90 or the terminal device 60 includes a long-distance communication circuit 712, a complementary metal oxide semiconductor (CMOS) sensor 713, an imaging element I/F 714, a microphone 715, a speaker 716, a sound input and output (I/O) I/F 717, a display 718, and an external device connection I/F 719, a short-range communication circuit 720, an antenna 720a of the short-range communication circuit 720, and a touch panel 721.

The long-distance communication circuit 712 is a circuit that allows communication with other devices through a communication network. The CMOS sensor 713 is an example of a built-in imaging element that captures an object (mainly, a self-image of a user operating the terminal device 60) under control of the CPU 701 to obtain image data. In alternative to the CMOS sensor, an imaging element such as a charge-coupled device (CCD) sensor may be used. The imaging element I/F 714 is a circuit that controls driving of the CMOS sensor 713. The microphone 715 is a built-in circuit that converts sound into an electric signal. The microphone 715 acquires voice and sound waves emitted from an external speaker, etc., and acquires information using electrical signals. The speaker 716 is a built-in circuit that generates sound such as music or voice by converting an electric signal into physical vibration. The sound I/O I/F 717 is a circuit for inputting or outputting an audio signal between the microphone 715 and the speaker 716 under control of the CPU 701. The display 718 is an example of a display device that displays an image of the object, various icons, etc. Examples of the display 718 include a liquid crystal display (LCD) and an organic electroluminescence (EL) display. The external device connection I/F 719 is an interface for connecting various external devices. The short-range communication circuit 720 is a communication circuit that communicates in compliance with the near field communication (NFC), the Bluetooth (Registered Trademark), and the like. The touch panel 721 is an example of an input device that allows a user to operate the meeting room terminal 90 by touching a screen of the display 718. The imaging device such as the CMOS sensor 713, the short-range communication device such as the short-range communication circuit 720, the voice input device such as the microphone 715, and the like are information acquisition devices that acquire resource identification information by, for example, an image such as an image code, wireless communication, or sound waves.

Further, the meeting room terminal 90 or the terminal device 60 includes a bus line 710. Examples of the bus line 710 include, but not limited to, an address bus and a data bus, which electrically connects the components illustrated in FIG. 5 such as the CPU 701.

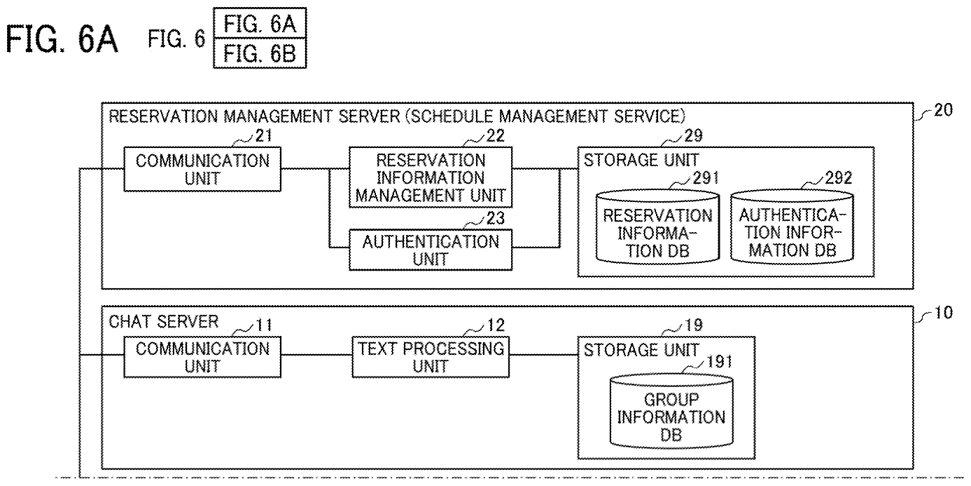

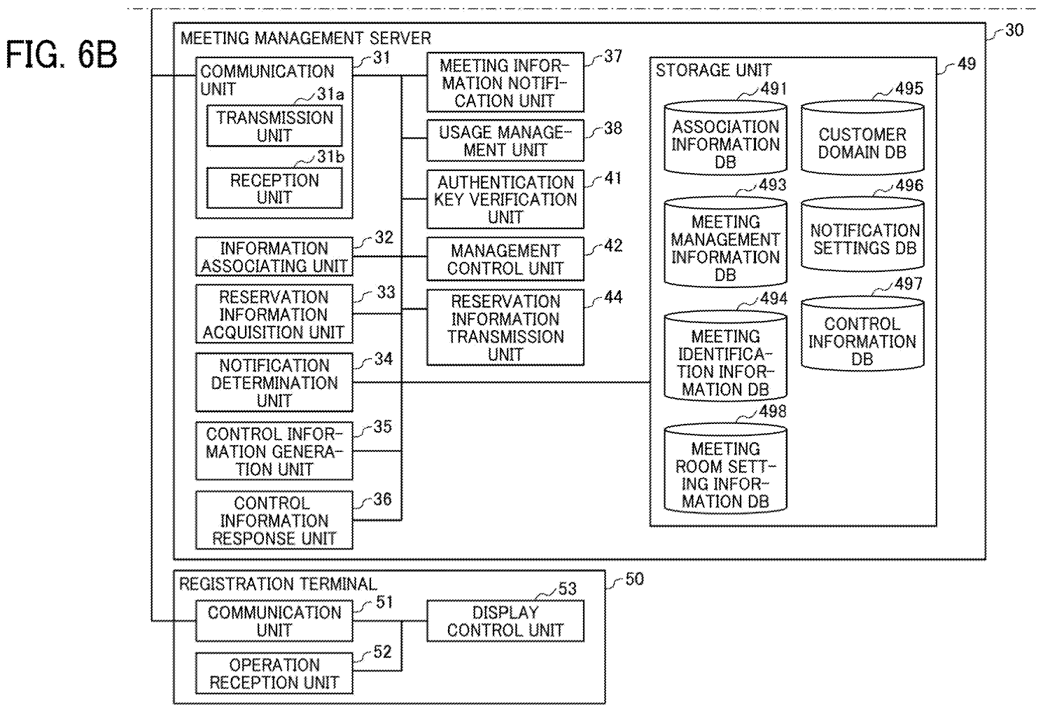

FIGS. 6A and 6B are block diagrams illustrating functional configuration of a reservation management server 20, a chat server 10, a meeting management server 30, and a registration terminal 50 according to the present embodiment.

The reservation management server 20 includes a communication unit 21, a reservation information management unit 22, and an authentication unit 23. Each of these functional units included in the reservation management server 20 is a function implemented by operating any of the components illustrated in FIG. 4 by an instruction from the CPU 201 according to a program developed from the HD 204 to the RAM 203.

The communication unit 21 transmits and receives various types of information to and from the meeting management server 30 and the terminal device 60. The communication unit 21 transmits screen information of a reservation setting screen to the terminal device 60 and receives a reservation setting or an authentication request from the terminal device 60. Further, the communication unit 21 transmits reservation information to the meeting management server 30.

The reservation information management unit 22 manages reservation information registered by a user. The reservation information management unit 22 reads the reservation information of the meeting room 6 requested from the meeting management server 30 from a reservation information DB 291 and transmits the reservation information to the meeting management server 30 through the communication unit 21. Alternatively, when the reservation information is registered (or changed), the reservation information is transmitted to the meeting management server 30 even if the request is not received. A general-purpose web application is used to enable a user who is to make a reservation to register a reservation for the meeting room 6 with the reservation management server 20.

The authentication unit 23 authenticates the user based on authentication information (for example, a user ID and password) stored in an authentication information DB 292. An integrated circuit (IC) card or biometric authentication information may be used for the authentication.

The reservation management server 20 further includes a storage unit 29. The storage unit 29 is implemented by, for example, the RAM 203, the HD204 and the like of FIG. 4. The reservation information DB 291 and the authentication information DB 292 are stored in the storage unit 29.

TABLE 1
Reservation Information DB

| | Reservation- | | | | | Expected |
|---|---|---|---|---|---|---|
| Reservation | making user | Meeting | Meeting | Start | End | participant |
| ID | account | name | room ID | time | time | account |
| 001 | a@xfood.com | Product Z | K-001 | Jul. 7, 2017 | Jul. 7, 2017 | b@xfood.com |
| | | development | | 10:00 | 12:00 | c@xfood.com |
| | | meeting | | | | d@xfood.com |
| 002 | e@xfood.com | Product Y | K-001 | Jul. 7, 2017 | Jul. 7, 2017 | f@xfood.com |
| | | development | | 13:00 | 14:00 | g@xfood.com |
| | | meeting | | | | |
| . . . | . . . | . . . | . . . | . . . | . . . | . . . |

Table 1 illustrates an example data structure of reservation information stored in the reservation information DB 291. The reservation information is information for managing a reservation status of the meeting room 6. The reservation information includes, for each of reservation IDs, an account of reservation-making user, a meeting name, a meeting room ID, a start time of the meeting, an end time of the meeting, and accounts of expected participants in association with the reservation ID. The reservation ID is identification information for identifying one record of the reservation information. ID is an abbreviation for “identification,” and indicates an identifier or identification information. ID is any one of a name, a symbol, a character string, a numerical value, or a combination of at least two of these items, which is used for identifying a particular object from among a plurality of objects. The same applies to other IDs than the reservation ID. The account of the reservation-making user is an account of an expected participant who made a reservation for the meeting room 6. The meeting name is a name of a meeting, which is given by the expected participant at participant's choice. The meeting room ID is identification information for identifying the meeting room 6 that resides on the intra-company network N1. The start time is the beginning of a time slot during which the meeting room 6 is reserved. In other words, the start time is a time when the meeting is to be started. The end time is the end of the time slot during which the meeting room 6 is reserved. In other words, the end time is a time when the meeting is to be ended. The accounts of expected participants are accounts of participants who are scheduled to attend the meeting. Each of the accounts in Table 1 is issued by the reservation management server 20.

TABLE 2
Authentication Information DB

| Customer ID | Password | User ID |
|---|---|---|
| G-001 | ********** | a@xfood.com |

Table 2 illustrates an example data structure of authentication information stored in the authentication information DB 292. The authentication information is information for a user (reservation-making user or participant) to log in to the reservation management server 20. The login information includes the user ID and the password. When the authentication is successful, the user can log in. Since the user ID is the same as the account of the reservation-making user or the participant, the meeting management server 30 can identify by the user ID, whether the reservation information is of the reservation-making user or of a participant.

The chat server 10 includes a communication unit 11 and a text processing unit 12. Each of these functional units included in the chat server 10 is a function implemented by operating any of the components illustrated in FIG. 4 by an instruction from the CPU 201 according to a program developed from the HD 204 to the RAM 203.

The communication unit 11 transmits and receives various types of information to and from the meeting management server 30. In the present embodiment, the communication unit 11 receives, from the meeting management server 30, information about reservation of a meeting room, information for identifying the bot, and information identifying a group as a destination to which a notification is to be sent. Examples of the information for identifying the bot include a token described below. The information for identifying the bot is notified in advance as identification information of the bot from the chat server 10, when generating the bot of the meeting management server 30. Further, the communication unit 11 may receive information designating an account of an individual such as a reservation-making user. Furthermore, the communication unit 11 transmits, to the meeting management server 30, information indicating that an expected participant has read the information about the reservation of the meeting room or a response made by an expected participant to the displayed information about the reservation of the meeting room.

Based on the information transmitted from the meeting management server 30, i.e., the information identifying the bot and the information identifying the group as a destination to which the notification is to be sent, the text processing unit 12 transmits, to the expected participants belonging to the group, information about the reservation of the meeting room 6 as information that the bot sends. In one example, the number of notifications transmitted by the text processing unit 12 is equal to the number of the expected participants. In another example, the notification is transmitted only to the reservation-making user or only to user(s) registered as a notification destination. In addition, information regarding the reservation of the meeting room 6 is transmitted only to a specific notification destination.

The text processing unit 12 is configured to send a so-called “push notification”. An example of a mechanism implementing the push notification is as follows. The chat application 60a receives an ID (token) for a push notification from a server operated by a manufacturer of an OS. The server associates the token with a device (terminal device 60). The chat application 60a registers the token and an account of the chat application 60a in the chat server 10. Since the chat server 10 identifies an account of the chat application 60a when sending a push notification, the token associated with the account is identified. The chat system designates the token and transmits a notification content to the server operated by the manufacturer of the OS. The server sends a push notification to a device (terminal device 60) associated with the token.

The chat server 10 further includes a storage unit 19. The storage unit 19 is implemented by, for example, the RAM 203, the HD204 and the like of FIG. 4. The storage unit 19 stores a group information DB 191.

TABLE 3
Group Information DB

| | | Member | Member | Member | Member | Bot |
|---|---|---|---|---|---|---|
| Workspace | Channel | account 1 | account 2 | account 3 | account 4 | account |
| http://sample.com/1 | #marketing | a@chat.com | b@chat.com | c@chat.com | d@chat.com | robo@chat.com |
| http://sample.com/2 | #team1 | b@chat.com | d@chat.com | | | |
| http://sample.com/3 | #ip | f@chat.com | g@chat.com | h@chat.com | | robo@chat.com |
| . . . | . . . | . . . | . . . | . . . | . . . | . . . |

Table 3 illustrates an example data structure of group information stored in the group information DB 191. The group information is information in which accounts of members belonging to the same group are registered. In the group information, member accounts 1 to n (n=4 in Table 3) and a bot account are registered in association with a workspace and a channel.

A workspace is identification information for identifying an organization such as a company or a department. In the present embodiment, plural members belong to a workspace (for example, Company A). Examples of the workspace include a uniform resource locator (URL). Alternatively, any suitable information other than the URL is used as the workspace, provided that the information is unique. Further, the workspace has plural channels according to the purposes of chatting. A channel is a group of members among whom information to be shared is exchanged, such as a group for product A and a group for product B. One or more members of the members belonging to the workspace belong to the channel. In other words, the notification destination is identified by the workspace and the channel Since the method of identifying the notification destination differs depending on the chat system, if there is identification information that can uniquely identify the group, that information alone may be used, or the notification destination may be identified by three or more pieces of information.

The channels are uniquely identified from one another. The member accounts 1 to n are accounts of members belonging to the channel. Each of these accounts is issued by the chat server 10. In the present embodiment, the bot is registered as a member for notifying other members belonging to the same group of information about the reservation of the meeting room 6. In other words, the bot is a kind of a proxy of the meeting management server 30 or an imaginary member. A comment (text) by the bot is transmitted to the terminal device 60 of each of the member accounts 1 to n.

The workspace and channel are managed by the meeting management server 30. The workspace and channel are information for identifying the group to which the participant belongs.

The meeting management server 30 includes a communication unit 31, an information associating unit 32, a reservation information acquisition unit 33, a notification determination unit 34, a control information generation unit 35, a control information response unit 36, a meeting information notification unit 37, a usage management unit 38, an authentication key verification unit 41, a management control unit 42, and a reservation information transmission unit 44. Each of these functional units included in the meeting management server 30 is a function implemented by operating any of the components illustrated in FIG. 4 by an instruction from the CPU 201 according to a program developed from the HD 204 to the RAM 203. The program is distributed from a server for program distribution or in a storage medium.

The communication unit 31 transmits and receives various kinds of information to and from the reservation management server 20, the chat server 10, the registration terminal 50, and the terminal device 60. The communication unit 31 includes a transmission unit 31a and a reception unit 31b. The reception unit 31b receives reservation information from the reservation management server 20 and receives a request for reservation information from the meeting room terminal 90 or the terminal device 60. Further, the reception unit 3 lb receives the check-in request and check-out requests from the meeting room terminal 90 or the terminal device 60. Furthermore, the reception unit 3 lb receives, from the registration terminal 50 operated by the administrator, information indicating an association between the group of the chat system and the account. The transmission unit 31a transmits information relating to reservation of a meeting room to the chat server 10 and transmits the reservation information to the meeting room terminal 90 or the terminal device 60.

The information associating unit 32 mainly performs processing relating to a preliminary registration process. Specifically, the information associating unit 32 receives a registration of a domain from the registration terminal 50 or the like operated by the administrator and registers the domain with a customer domain DB 495. Further, the information associating unit 32 stores the workspace and the channel of the chat system transmitted from the registration terminal 50 or the like in association with the account of the reservation management server 20 in an association information DB 491.

The reservation information acquisition unit 33 obtains the reservation information from the reservation management server 20 by designating an account of a customer who uses the resource reservation system 100. The reservation information acquisition unit 33 registers the obtained reservation information as meeting management information with a meeting management information DB 493. Alternatively, the reservation information acquisition unit 33 receives the changed reservation information. At least a part of the reservation information stored in the reservation management server 20 is stored in the meeting management information DB 493. More specifically, the reservation information acquisition unit 33 obtains the reservation information for a predetermined period in the future from the current time among the reservation information stored in the reservation management server 20. The predetermined period is determined depending on how long a period ahead is set to future meetings for which the information about the reservation of the meeting room 6 is to be notified.

The notification determination unit 34 determines whether the meeting management information includes a reservation whose start time satisfies a condition for notification. For example, the notification determination unit 34 refers to a notification settings DB 496 to determine whether the current time matches a date and time obtained by subtracting a preset period from the start time of the reservation. When the current time matches the obtained date and time by this subtraction, the notification determination unit 34 determines that a notification is to be sent. For example, when there are plural bots according to different roles, such as a bot for sending a reminder and a bot for receiving a reservation, the notification determination unit 34 determines a suitable bot according to processing to be performed.

When the notification determination unit 34 determines that the notification is to be sent, the meeting information notification unit 37 designate information identifying the bot (e.g., a token in Slack) and information identifying the group as the notification destination, to request the chat server 10 to transmit a notification of the information about the reservation of the meeting room 6. Note that the notification is performed several times, and the meeting identification information is included in at least one of the notifications. The meeting identification information is information for the meeting management server 30 to confirm whether the participant has a right to use the reserved meeting room 6 during the reserved time slot. The meeting information notification unit 37 generates the meeting identification information by the final notification at the latest. The meeting identification information is registered in a meeting identification information DB 494.

The control information generation unit 35 refers to the meeting management information to generate control information for the electronic device 70 and registers the generated control information in a control information DB 497. For example, the control information generation unit 35 generates control information for turning on the power of the electronic device 70 several minutes before the start time of the meeting. Further, the control information generation unit 35 generates control information for turning off the power of the electronic device 70 in response to detection of the check-out. The control information is stored in the control information DB 497.

In response to receiving an inquiry from the terminal device 60 or the meeting room terminal 90 provided in the meeting room 6 as to whether there is control information, the control information response unit 36 refers to the control information DB 497 to transmit the control information corresponding to the meeting room 6 to the terminal device 60 or the meeting room terminal 90.

The usage management unit 38 manages check-in (start of use) and check-out (end of use) to the meeting room. Further, the usage management unit 38 registers, in the meeting management information DB 493, a change in the status of meeting according to the check-in and the check-out. The check-in is allowed from 5 to10 minutes before the start time of the meeting identified by the reservation ID. The status is changed to “waiting for check-in”.
When a check-in request is received from the meeting room terminal 90, check-in is permitted when a set of the meeting room ID and the meeting identification information (invitation code) transmitted by the meeting room terminal 90 is registered in the meeting identification information DB 494.
When a check-in request is received from the terminal device 60, the authentication key, the email address of the meeting room, the meeting room ID, and the user ID are transmitted from the terminal device 60. The usage management unit 38 authenticates that the image code has been captured (the user is in the meeting room) using the authentication key. In addition, the reservation information of the meeting room is identified by the meeting room ID, and check-in is permitted when the user ID is included in the account of the reservation-making user, (or the expected participant account) of the identified reservation information.

As a method for the usage management unit 38 to determine whether the check-in request is from the meeting room terminal 90 or the check-in request from the terminal device 60, the meeting application 60b and the terminal application 90a may each notify the meeting management server 30 of the type of application. Alternatively, the meeting application 60b may notify the meeting management server 30 that the information is obtained from the image code at check-in. In addition, as long as the meeting room terminal 90 and the terminal device 60 can be distinguished from each other, the usage management unit 38 can determine whether the check-in request is from the meeting room terminal 90 or from the terminal device 60.

The usage management unit 38 cancels the reservation if the check-in is not permitted by a fixed time.

The authentication key verification unit 41 authenticates the meeting room terminal 90 or the terminal device 60 depending on whether the authentication key transmitted from the meeting room terminal 90 or the terminal device 60 matches the authentication key registered in the meeting room setting information DB 498. Therefore, only the meeting room terminal 90 having the correct authentication key or the terminal device 60 that transmitted the correct authentication key can acquire the reservation information. In the present embodiment, since the terminal device 60 can acquire the reservation information, it is possible to prevent a third party from acquiring the reservation information from the outside (a place without an image code) by using the authentication key.

The management control unit 42 confirms whether or not the management start flag registered in the meeting room setting information DB 498 is true for each meeting room. The management start flag is a flag indicating whether or not the management of the meeting room may be started.

The reservation information transmission unit 44 transmits the reservation information (meeting management information) stored in the meeting management information DB 493 in response to a request from the meeting room terminal 90 or the terminal device 60. However, the authentication with the authentication key must be successful and the management start flag must be set to true. In response to the request from the terminal device 60, the meeting name and the reservation information are processed (for example, masking the meeting name and the participant name) depending on whether the user of the terminal device 60 is a reservation-making user or a participant. The reservation information transmission unit 44 can transmit the reservation information in Java Script Object Notation (JSON) format, Extensible Markup Language (XML) format, Comma-Separated Values (CVS) format, or the like. Since the reservation information is repeatedly transmitted, a format having a smaller data size is advantageous.

The meeting management server 30 further includes a storage unit 49. The storage unit 49 is implemented by, for example, the RAM 203, the HD204 and the like of FIG. 4. The storage unit 49 stores an association information DB 491, a meeting management information DB 493, a meeting identification information DB 494, a customer domain DB 495, a notification settings DB 496, a control information DB 497, and a meeting room setting information DB 498.

TABLE 4
Association Information DB

| | | Member | Member | Member | Member |
|---|---|---|---|---|---|
| Workspace | Channel | account 1 | account 2 | account 3 | account 4 |
| http://sample.com/1 | #marketing | a@xfood.com | b@xfood.com | c@xfood.com | d@xfood.com |
| | | a@chat.com | b@chat.com | c@chat.com | d@chat.com |
| http://sample.com/2 | #team1 | f@xfood.com | g@xfood.com | h@xfood.com | |
| | | f@chat.com | g@chat.com | h@chat.com | |
| . . . | . . . | . . . | . . . | . . . | . . . |

Table 4 illustrates an example data structure of association information stored in the association information DB 491. The association information is information associating the account of the reservation management system with the group of the chat system. The association information includes items of the workspace, the channel and the member accounts 1 to n (n=4 in Table 4). The same description given above with reference to Table 2 of the workspace and the channel applies to the workspace and the channel of Table 4. In the member accounts 1 to n, the accounts of participants issued by the reservation management server 20 are registered. The accounts of the chat system may also be registered in the association information, as indicated in Table 4. To send a notification to the group, information identifying the account, issued by the reservation management server 20, of the user who made a reservation of a meeting to the reservation management server 20 and information (in the present embodiment, the workspace and the channel name) identifying the group and channel of the notification destination will suffice. In other words, the accounts of all the members belonging to the group are not necessarily registered in the association information. However, the account information of the chat system of each individual user is required when sending a notification to the individual user. Accordingly, the account of the user of the chat system may also be registered in the association information, as indicated in Table 4.

TABLE 5
Meeting Management Information DB

| | Account of | | | | | Account of | |
|---|---|---|---|---|---|---|---|
| Reservation | reservation- | Meeting | Meeting | Start | End | expected | |
| ID | making user | name | room ID | time | time | participant | Status |
| 001 | a@xfood.com | Product Z | K-001 | 2017 Jul. 7 | 2017 Jul. 7 | b@xfood.com | Checked |
| | | development | | 10:00 | 12:00 | c@xfood.com | in |
| | | meeting | | | | d@xfood.com | |

Table 5 illustrates an example data structure of the meeting management information stored in the meeting management information DB 493 of the meeting management server 30. Since the reservation information is stored in the meeting management information DB 493, the difference from the reservation information DB 291 in Table 1 is described in Table 5. The meeting management information in Table 5 includes “status” as an item. The status indicates the status of a reservation. For example, the status registered in the meeting management information of Table 5 indicates whether a notification of the information about the reservation of the meeting room 6 has been sent, whether the use of the meeting room has been confirmed, whether the check-in operation has been performed, whether the check-out operation has been performed, and whether the reservation has been cancelled.

TABLE 6
Meeting Identification Information DB

| | | Meeting |
|---|---|---|
| | | identification |
| Reservation ID | Meeting room ID | information |
| 001 | K-001 | 1234 |
| 002 | K-002 | 5678 |
| . . . | . . . | . . . |

Table 6 illustrates an example data structure of meeting identification information management information stored in the meeting identification information DB 494. The meeting identification information management information is information for managing the meeting identification information for each reservation of the meeting room 6. The meeting identification information management information includes items of the reservation ID, the meeting room ID, and the meeting identification information. The reservation ID, the meeting room ID, and the meeting identification information of the meeting identification information management information in Table 6 are the same or substantially the same as those of the reservation information (the reservation information acquired from the reservation management server 20), which further includes status. Accordingly, the redundant descriptions thereof are omitted. Note that the reservation ID is registered in order to identify the reservation of the same meeting room 6. The status indicates the status of a reservation. For example, the status registered in the reservation information of Table 6 indicates whether a notification of the information about the reservation of the meeting room has been sent, whether the use of the meeting room has been confirmed, whether the check-in operation has been performed, whether the check-out operation has been performed, or whether the reservation has been cancelled.

TABLE 7
Customer Domain DB

| Customer domain name | Customer administrator's account |
|---|---|
| xfood.com | a@xfood.com |
| ycar.com | f@ycar.com |
| . . . | . . . |

Table 7 illustrates an example data structure of customer domain information stored in the customer domain DB 495. The customer domain information is information for managing a customer's domain name and an account of an administrator of the customer. The customer domain information stores a domain name of a customer with an administrator's account. The domain name of the customer in Table 7 is the domain name of the account (email address) issued by the reservation management server 20. The administrator's account is an account of an administrator (representative) of the customer. The reservation management server 20 issues the accounts in Table 7.

TABLE 8
Notification Settings DB

| Customer domain name | Notification setting |
|---|---|
| xfood.com | One day before |
| ycar.com | 12 hours before |
| . . . | . . . |

Table 8 illustrates an example data structure of notification setting information stored in the notification settings DB 496. The notification setting information includes, for each of the customers, settings relating to a notification. The notification setting information stores the domain name of the customer in association with notification settings. The notification settings indicates a tuning at which the information about the reservation of the meeting room 6 is to be notified. In this example, the timing defines how long ahead the start time of the meeting the notification of the information about the reservation of the meeting room is to be sent. In another example, a fixed date and time may be set in the notification settings. Further, the number of the timings set in the notification settings is not necessarily one. A plurality of notification settings may be registered in association with one customer.

TABLE 9
Control Information DB

| | | | | | | Number of | |
|---|---|---|---|---|---|---|---|
| | | | | | | registrable | |
| | Meeting | | Status of | | | meeting | |
| Customer | room | Meeting | meeting room | Authentication | Management | room | Email |
| ID | name | room ID | terminal | key | start flag | terminals | address |
| G-001 | Meeting | K-001 | Connected | ***** | True | 1 | K_001@xfood.com |
| | room A | | | | | | |
| | Meeting | K-002 | Before Setup | ***** | False | 1 | K_001@xfood.com |
| | room B | | | | | | |
| | Meeting | K-003 | Disconnected | ***** | True | 2 | K_001@xfood.com |
| | room C | | | | | | |

Table 9 illustrates an example data structure of control information stored in the control information DB 497. The control information is information for controlling the electronic device 70 located in the meeting room 6. The control information includes the meeting room ID and a control content. The control content indicates a specific control operation of the electronic device 70. The meeting management server 30 can set a detailed control content for each electronic device 70. The control information does not include information indicating a time at which the electronic device 70 is to be controlled. This is because it is difficult for the meeting management server 30 to access the meeting room terminal 90 or the terminal device 60, since the meeting management server 30 resides on the external network N2. Accordingly, the meeting management server 30 transmits the control content when the control information has already been generated and when being accessed from the meeting room terminal 90 or the terminal device 60.

TABLE 10
Meeting Room Setting Information DB

| | | | | | | Number of | |
|---|---|---|---|---|---|---|---|
| | | | | | | registrable | |
| | Meeting | | Status of | | | meeting | |
| Customer | room | Meeting | meeting room | Authentication | Management | room | Email |
| ID | name | room ID | terminal | key | start flag | terminals | address |
| G-001 | Meeting | K-001 | Connected | ***** | True | 1 | K_001@xfood.com |
| | room A | | | | | | |
| | Meeting | K-002 | Before Setup | ***** | False | 1 | K_001@xfood.com |
| | room B | | | | | | |
| | Meeting | K-003 | Disconnected | ***** | True | 2 | K_001@xfood.com |
| | room C | | | | | | |

Table 10 illustrates an example data structure of meeting room setting information stored in the meeting room setting information DB 498. The meeting room setting information is information relating to settings of each meeting room. The meeting room setting information includes, in association with the customer ID, items of a meeting room name, the meeting room ID, status of the meeting room terminal, the authentication key, a management start flag, the number of meeting room terminals that can be registered, and email address. The meeting room name is a general-purpose name of a meeting room recognized by participants attending in the meeting. Examples of the meeting room name include a name that is presented at the entrance of the meeting room. The meeting room ID is identification information for uniquely identifying a meeting room, as described above. In one example, the meeting room ID are common to the meeting room setting information and the reservation management server 20, to simplify the configuration and operation. In another example, a conversion table is provided that allows the administrator to set the different meeting room ID from the meeting room ID stored in the reservation management server 20. The meeting room ID is decoded into an image code presented in the meeting room. The status of the meeting room terminal indicates whether the configuration of initial settings of the meeting room terminal 90 has been completed, whether communication is possible, and the like. In a meeting room where the meeting room terminal 90 is not provided, the status of the meeting room is indicated as “before setup”. The initial settings refers to, for example, communication-related settings so that the meeting room terminal 90 can exhibit at least the minimum functions. “Connected” in the status of the meeting room terminal indicates status in which communication is confirmed within a certain time period. “Before setup” in the status of the meeting room terminal indicates status in which the initial settings has not been configured yet. “Disconnected” in the status of the meeting room terminal indicates status in which no communication has been performed for equal to or longer than a certain time period. The authentication key is authentication information used by the meeting management server 30 to authenticate the meeting room terminal 90 or the terminal device 60. The authentication key is set to the meeting room terminal 90 by the initial settings. The meeting room ID is decoded into an image code presented in the meeting room in a meeting room without the meeting room terminal 90. The authentication key is a combination of numbers, alphabets, symbols, and the like that are too long to be identified by a brute force attack. In one example, the meeting management server 30 determines the authentication key. In another example, the administrator determines the authentication key. The management start flag is a flag indicating whether the meeting management server 30 starts managing the meeting room after the initial settings of the meeting room terminal 90 has been configured. The value “true” set in the management start flag indicates that the meeting management server 30 starts managing the meeting room. The value “false” set in the management start flag indicates that the meeting management server 30 does not start managing the meeting room. The management start flag is set by the administrator. In a meeting room where the meeting room terminal 90 is not installed, the administrator may set the management start flag to true as appropriate.

When the management start flag is set to True, the meeting management server 30 is ready to manage the meeting room. The meeting management server 30 starts the management of the meeting room when the management start flag is True and the request for reservation information is received from the meeting room terminal 90 or the terminal device 60. As a result, transmission of reservation information is started when there is a request from the meeting room terminal 90 or the terminal device 60.

When the meeting room terminal 90 acquires the reservation information from the meeting management server 30, the meeting room terminal 90 starts cooperation with the meeting management server 30. Therefore, the start of cooperation and the start of management are triggered by the related processes of requesting reservation information and transmitting reservation information.

The following processing is performed when cooperation is started, or management is started;
display of reservation information (check-in, check-out, extension, use now);
control of electronic devices linked to check-in and check-out;
automatic cancellation of reservation.

Note that “extension” indicates that the participant extends the reservation beyond the end time of the reservation of the meeting room, and “use now” indicates that any user can use the vacant meeting room without reservation.

The management start flag substantially eliminates inconveniences such as automatic cancellation caused by a time lag between the time when the configuration of the initial settings is completed and the time when the meeting room terminal 90 is arranged in the meeting room. Since the management start flag is set to True even in the meeting room where the meeting room terminal 90 is not provided, the reservation information can be displayed or automatically canceled. The number of meeting room terminals 90 that can be registered indicates the number of meeting room terminals 90 that can be associated with one meeting room. One meeting room terminal 90 in one meeting room is sufficient, but in a case where any malfunction occurs in the meeting room terminal 90, the user will have difficulty in checking in the meeting room until the repair of the meeting room terminal 90 is done. To address such situation, the administrator may want to associate plural meeting room terminals 90 with one meeting room. Therefore, even if the authentication key is revealed, since the terminal ID matches and the number of the meeting room terminals 90 is set in advance, reservation information is prevented from being revealed. The default value of the number of the meeting room terminals 90 can be either one or n (n is equal to or more than 2). The email address is for the meeting management server 30 or the like to send an email to the meeting room. In the present embodiment, the email address may be used as a meeting room ID. The email address is decoded into the image code presented in the meeting room.

In one example, the meeting room name and the meeting room ID are determined in advance. In another example, the administrator sets the meeting room name and the meeting room ID. In still another example, the meeting room name and the meeting room ID transmitted from the reservation management server 20 are used. The default value (the value immediately after setting by a provider) of the status of the meeting room terminal is “before setup”, but the value automatically transitions according to the communication status. The value of the authentication key is assigned and set by the meeting management server 30 at the time of initial settings, for example. The management start flag is set by the administrator through a setting screen for the administrator described below. The value of the number of meeting room terminals 90 that can be registered is also set by the administrator. In most cases, the value of the number of meeting room terminals 90 that can be registered is equal to or more than one. When the value of the number of meeting room terminals 90 that can be registered is set to one, only one meeting room terminal 90 can be registered in one meeting room. The email address can be set by the administrator.

When the administrator sets the meeting room ID, the authentication key, and the email address, the image code of the meeting room information including the meeting room ID, the authentication key, and the email address can be printed from a printer or the like. It is preferable that the meeting room information is encrypted so that a third party cannot obtain the reservation information at the time of leakage.

The registration terminal 50 includes a communication unit 51, an operation reception unit 52, and a display control unit 53. Each of these functional units included in the registration terminal 50 is a function implemented by operating any of the components illustrated in FIG. 4 by an instruction from the CPU 201 according to a program developed from the HD 204 to the RAM 203. The program (for example, a browser) is distributed from a server for program distribution or in a storage medium.

The registration terminal 50 is a terminal for the administrator to make various settings related to the meeting room through the web page provided by the meeting management server 30. One of these settings is the initial settings. The terminal device 60 may be used for the initial settings.

The communication unit 51 transmits and receives various types of information to and from the meeting management server 30 and the reservation management server 20. The operation reception unit 52 receives various operations of the participant with respect to the registration terminal 50. The display control unit 53 interprets screen information of various screens to display screens on the display 206. The operation reception unit 52 and the display control unit 53 includes, for example, a browser function and can execute a web application.

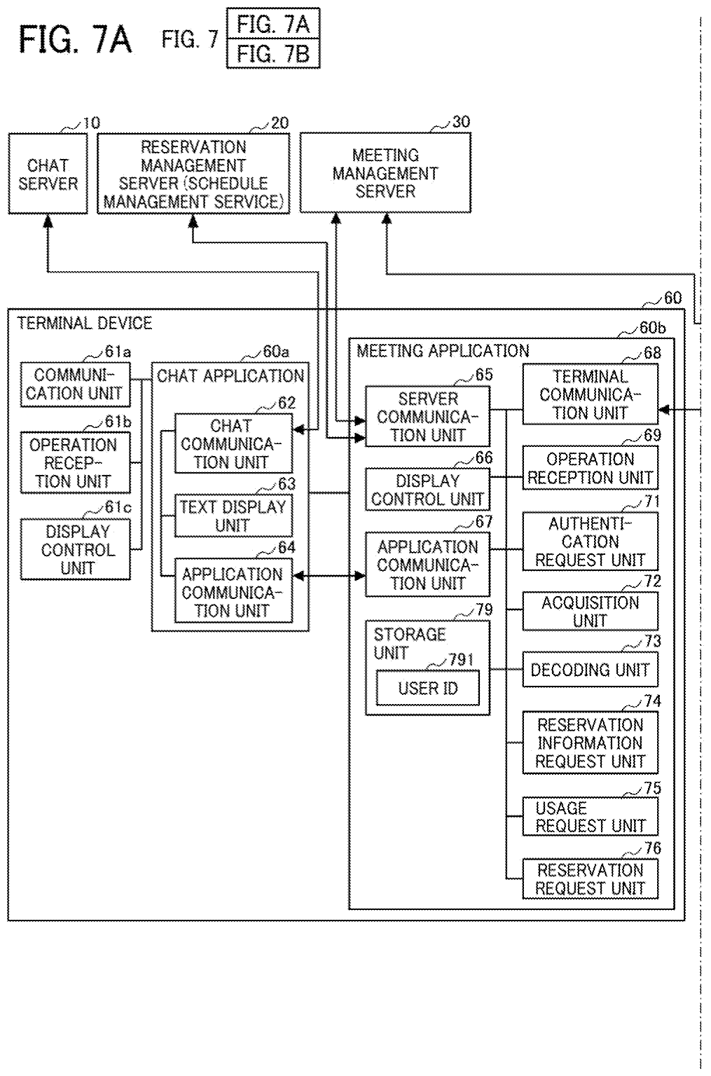

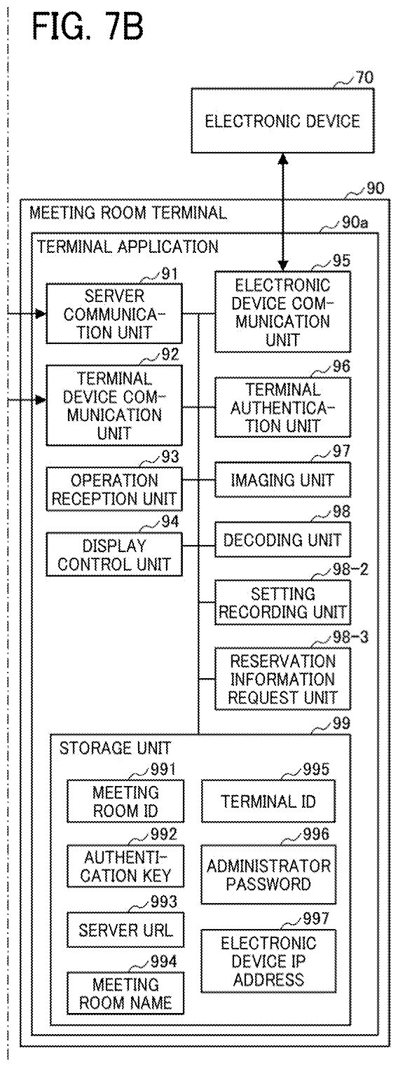

FIGS. 7A and 7B are block diagrams illustrating a functional configuration of the terminal device 60 and the meeting room terminal 90 according to the present embodiment. The functions of the electronic device 70 is described as needed.

The terminal device 60 includes a communication unit 61a, an operation reception unit 61b, a display control unit 61c, a chat application 60a, and a meeting application 60b. Further, the chat application 60a includes a chat communication unit 62, a text display unit 63, and an application communication unit 64. The meeting application 60b includes a server communication unit 65, a display control unit 66, an application communication unit 67, a terminal communication unit 68, an operation reception unit 69, an authentication request unit 71, an acquisition unit 72, a decoding unit 73, a reservation information request unit 74, a usage request unit 75 and a reservation request unit 76. Each of these functional units included in the terminal device 60 is a function implemented by operating any of the configuration categories illustrated in FIG. 5 by an instruction from the CPU 701 according to a program developed from the EEPROM 704 to the RAM 703. The program is distributed from a server for program distribution or in a storage medium. Since the chat application 60a and the meeting application 60b operate on the terminal device 60, the program includes the chat application 60a and the meeting application 60b.

The communication unit 61a transmits and receives various types of information to and from the meeting management server 30 and the reservation management server 20. The operation reception unit 61b receives various operations that are input by the participant to the terminal device 60. The display control unit 61c interprets screen information of various screens to display screens on the display 718. The operation reception unit 61b and the display control unit 61c includes, for example, a browser function and executes a web application.

The chat communication unit 62 of the chat application 60a transmits and receives various types of information to and from the chat server 10. In the present embodiment, the chat communication unit 62 receives information about the reservation of the meeting room 6 from the chat server 10. Further, the chat communication unit 62 sends, to the chat server 10, a notification indicating that a message of the information about the reservation of the meeting room 6 has been read and a notification indicating whether the meeting room 6 is to be used or canceled.

The text display unit 63 of the chat application 60a displays text (the information about the reservation of the meeting room 6) transmitted from the chat server 10. For example, the text display unit 63 displays the text as if the source of the message is the bot and as if the bot inputs the text.

The application communication unit 64 of the chat application 60a invokes the meeting application 60b and transmits the meeting identification information to the meeting application 60b. The chat server 10 transmits information identifying the meeting application 60b to the terminal device 60, when notifying the terminal device 60 of the information about the reservation of the meeting room 6. Accordingly, the chat application 60a designates the meeting application 60b to the OS and requests notification of the meeting identification information. The OS activates the meeting application 60b.

The server communication unit 65 of the meeting application 60b communicates with the meeting management server 30 or the reservation management server 20. The server communication unit 65 receives reservation information, and transmits a check-in request, a check-out request, and a reservation request to the meeting management server 30. Further, the server communication unit 65 transmits an authentication request to the reservation management server 20.

The display control unit 66 of the meeting application 60b displays an image code or the like including the meeting identification information on the display 718 for the meeting room terminal 90 when the meeting identification information is not input manually. When the terminal device 60 receives the reservation information from the meeting management server 30, the reservation information is displayed on the display 718.

The application communication unit 67 of the meeting application 60b obtains various kinds of information from the chat application 60a through the OS. Examples of the various kinds of information obtained from the chat application 60a include the meeting identification information included in the information about the reservation of the meeting room 6.

The terminal communication unit 68 communicates with the meeting room terminal 90 to transmit the meeting identification information, etc. when the meeting room terminal is provided in the meeting room. (However, the meeting identification information, etc. may be entered manually). The terminal communication unit 68 detects the meeting room terminal 90 using a short-range wireless communication network such as Bluetooth (registered trademark). In response to detecting the meeting room terminal 90, the terminal communication unit 68 transmits the meeting identification information to the detected meeting room terminal 90. The operation reception unit 69 receives various operations on the terminal device 60.

The authentication request unit 71 designates a user ID and password entered by the user, and requests authentication from the reservation management server 20 through the server communication unit 65. If the authentication is successful, the user ID 791 is stored in the storage unit 79.

The acquisition unit 72 captures the image code presented in the meeting room and acquires image data of the image code. The image code may be a barcode. The acquisition unit 72 may read characters and numbers instead of the image code by optical character reader (OCR). Further, the acquisition unit 72 may acquire the meeting room information by other methods. For example, the acquisition unit 72 may acquire the meeting room information from an IC card terminal or a Bluetooth (registered trademark) terminal provided in the meeting room. The meeting room information may be acquired not only by capturing the image but also by short-range wireless communication.

The decoding unit 73 decodes the image code captured by the acquisition unit 72 and restores the meeting room information. If the image code is encrypted, the decoding unit 73 decrypts the image code.

The reservation information request unit 74 can automatically request the reservation information from the meeting management server 30 without any operation in conjunction with the capturing of the image code. Alternatively, the reservation information may be requested according to a user's operation after the capturing of the image code. The usage request unit 75 requests the meeting management server 30 to check-in to the meeting room in conjunction with the capturing of the image code or in response to the user's operation. The reservation request unit 76 newly requests the reservation management server 20 to reserve the meeting room.

Further, the meeting application 60b includes a storage unit 79 implemented by the ROM 702, the RAM 703, the EEPROM 704, or the like. The user ID 791 is stored in the storage unit 79. The user ID 791 is stored when the authentication by the authentication request unit 71 is successful. The user ID 791 is, for example, a user account on the reservation management server 20.

The meeting room terminal 90 includes a server communication unit 91, a terminal device communication unit 92, an operation reception unit 93, a display control unit 94, an electronic device communication unit 95, a terminal authentication unit 96, an imaging unit 97, a decoding unit 98, a settings recording unit 98-2, and a reservation information request unit 98-3. Each of these functional units included in the meeting room terminal 90 is a function implemented by operating any of the configuration categories illustrated in FIG. 5 by an instruction from the CPU 701 according to a program developed from the EEPROM 704 to the RAM 703. The program is distributed from a server for program distribution or in a storage medium.

The server communication unit 91 communicates with the meeting management server 30 with a server URL 993 as a destination. Since the meeting room terminal 90 resides on the intra-company network N1, accessing from the meeting management server 30 to the meeting room terminal 90 is difficult. For this reason, the server communication unit 91 polls the meeting management server 30 to periodically communicate with the meeting management server 30. In addition to or in alternative to the polling, the server communication unit 91 communicates with the meeting management server 30 using a communication technology such as WebSocket. When the status of the meeting room terminal is “connected” and there is no communication from the server communication unit 91, “disconnected” is registered in the meeting room setting information DB 498. If the status of the meeting room terminal is “before setup”, the status of the meeting room terminal remains as “before setup” regardless of presence or absence of communication. The server communication unit 91 may communicate using a communication protocol such as Hypertext Transfer Protocol (HTTP), and the communication protocol is not particularly limited.

The server communication unit 91 according to the present embodiment receives the reservation information and transmits, to the meeting management server 30, the meeting identification information, which is received by the terminal device communication unit 92 from the terminal device 60 or manually input at the time of check-in. Further, the server communication unit 91 receives the control information from the meeting management server 30.

The terminal device communication unit 92 communicates with the terminal device 60. In the present embodiment, the terminal device communication unit 92 receives the meeting identification information, etc. The electronic device communication unit 95 communicates with the electronic device 70. In the present embodiment, the electronic device communication unit 95 transmits, to the electronic device 70, the control information received by the server communication unit 91.

The display control unit 94 displays a screen generated by the terminal application 90a on the display 718. The screen displayed by the display control unit 94 is a standby screen that receives a check-in and a check-out. The operation reception unit 93 receives various operations input to the meeting room terminal 90.

The terminal authentication unit 96 authenticates the administrator's login to the terminal application based on whether or not the entered administrator password is correct. The authentication is required because the meeting room terminal 90 provided in the meeting room may be operated by an unspecified participant, so that the initial settings may be changed if there is no authentication function.

The imaging unit 97 mainly captures the image code. When the administrator operates the meeting room terminal 90 so that the image code is captured in an angle of view of the CMOS sensor 713, the imaging unit 97 recognizes the image code (image code for initial settings) and automatically generates image data. The decoding unit 98 decodes the image code captured by the imaging unit 97 and restores the communication setting information. The settings recording unit 98-2 stores the communication setting information (meeting room ID, authentication key, server URL, meeting room name) decoded by the decoding unit 98 in the storage unit 99. The imaging unit 97, the decoding unit 98, and the settings recording unit 98-2 are all necessary processes at the time of initial setting of the meeting room terminal 90 and are not used in the present embodiment.

The reservation information request unit 98-3 repeatedly transmits the meeting room ID 991 and the authentication key 992 to the meeting management server 30 through the server communication unit 91 at a periodic time interval for acquiring the reservation information. As a response to the transmission of the meeting room ID 991 and the authentication key 992, the reservation information request unit 98-3 acquires the reservation information through the server communication unit 91. It is sufficient that the reservation information be acquired when any change is made in the reservation information. Examples of the periodical time interval for the reservation information request unit 98-4 to acquire the reservation information include from every several seconds to every several minutes. The shorter the periodical time interval, the sooner the reservation information is updated. However, the shorter the periodical time interval, communication load is greater. Accordingly, the periodical time interval is determined in view of both the update frequency of the reservation information and the communication load. In the present embodiment, the reservation information request unit 98-3 acquires the reservation information every thirty seconds, for example. Further, the reservation information request unit 98-3 receives at least the meeting management information (reservation information) of the meeting room 6 of the current day through the server communication unit 91.

The meeting room terminal 90 further includes the storage unit 99. The storage unit 99 is implemented by the ROM 702, the EEPROM 704, and the like of FIG. 5. The storage unit 99 stores the meeting room ID 991, the authentication key 992, the server URL 993, a meeting room name 994, a terminal ID 995, an administrator password 996, and an IP address 997 of the electronic device 70.

The terminal ID 995 is identification information identifying the meeting room terminal 90. The terminal ID is used by the meeting management server 30 to identify the meeting room terminals 90 in order to prevent more than a preset number of meeting room terminals 90 from being connected to the meeting management server 30 in one meeting room. Examples of the terminal ID include a universally unique identifier (UUID) of the terminal application and a MAC address. Any other suitable information may be used as the terminal ID, provided that the information is unique. The UUID is a unique identifier in a sense that two or more items do not have the same value all over the world without specific management.

The administrator password 996 is set by the administrator when the terminal application 90a is installed or when the terminal application 90a is activated for the first time. The IP address 997 of the electronic device 70 is set by the administrator as needed.

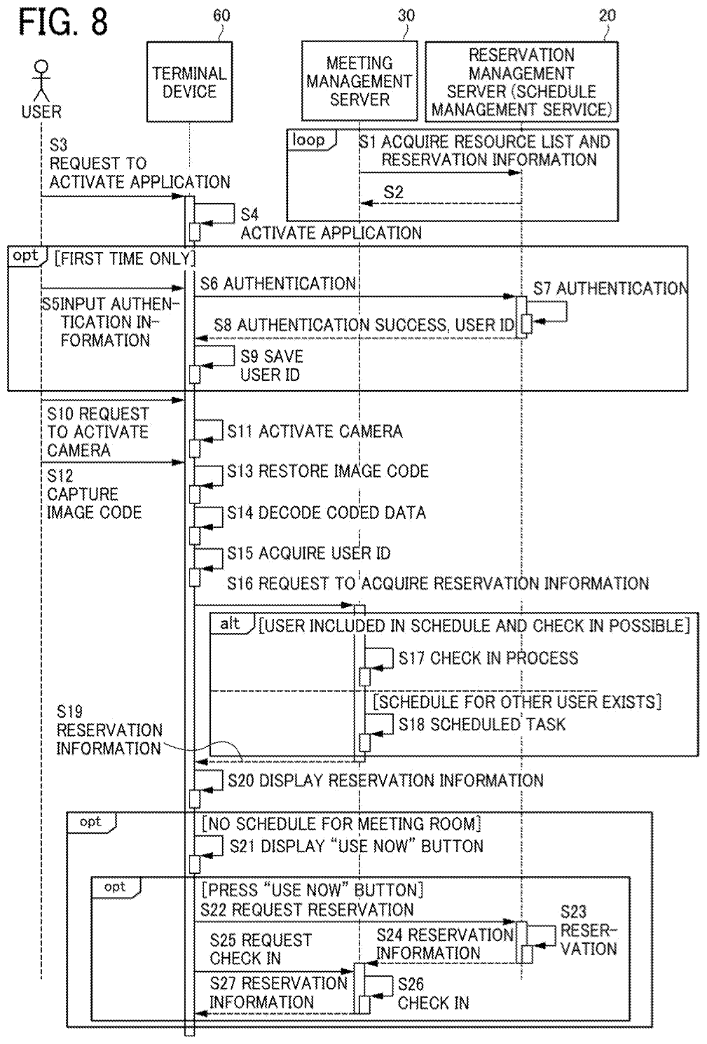

A process from the terminal device 60 displaying the reservation information to the user checking in is described with reference to FIG. 8. FIG. 8 is a sequence diagram illustrating an operation of the resource reservation system 100.

In steps S1 and S2, the reservation information acquisition unit 33 of the meeting management server 30 transmits a resource list request to the reservation management server 20 at a predetermined frequency. The resource list request indicates requesting a list of customer resources registered in the reservation management server 20. Since the meeting room is treated as a resource in the resource reservation system 100, the meeting management server 30 can acquire a list of the customer's meeting rooms by requesting the resource list. The predetermined frequency may be a relatively low frequency, for example, once a day. Resources include the meeting room as well as the electronic device 70.

Further, the reservation information acquisition unit 33 of the meeting management server 30 repeatedly transmits the reservation information acquisition request to the reservation management server 20. The reservation information acquisition request indicates designating a domain and requesting the reservation information of the person who has this domain in the account. As a result, the meeting management server 30 can acquire reservation information for a fixed period. The frequency of repetition is preferably relatively high, for example, every few minutes, every 30 minutes, or every hour. Further, regarding the reservation information, the newly registered or changed reservation information may be automatically transmitted from the reservation management server 20.

In step S3, a user who wants to check-in to the meeting room (reservation-making user, participant, or neither) activates the meeting application 60b on the terminal device 60.

In step S4, the activation request activates the meeting application 60b. The URLs of the meeting management server 30 and the reservation management server 20 are preset in the meeting application 60b. When the meeting application 60b is substituted by the browser software, the user may set the URL.

In step S5, the user inputs the authentication information of the reservation management server 20 into the terminal device 60. Since the meeting management server 30 identifies the user by using the user's account on the reservation management server 20, the user's account is substantially the same as the authentication information of the meeting management server 30. The user inputs a password and a user ID. The operation reception unit 69 of the terminal device 60 receives the authentication information. The authentication information only needs to be entered once. This is because the terminal device 60 is dedicated to the user and the user ID 791 is stored in the storage unit 79 when the authentication is successful.

In step S6, the authentication request unit 71 of the terminal device 60 transmits the authentication information to the reservation management server 20 through the server communication unit 65.

In step S7, he communication unit 21 of the reservation management server 20 receives the authentication information, and the authentication unit 23 refers to the authentication information DB 292 to authenticate the user. In the present embodiment, it is assumed that the authentication is successful.

In step S8, the communication unit 21 of the reservation management server 20 transmits the authentication success and the user ID to the terminal device 60.

In step S9, the server communication unit 65 of the terminal device 60 receives the authentication success and the user ID and stores the user ID 791 in the storage unit 79.

In step S10, the user performs an operation of activating the camera (CMOS sensor 713) on the terminal device 60.

In step S11, the user's operation activates the camera. The camera may be automatically activated in response to the activation of the meeting application 60b.

In step S12, the user performs an operation of capturing an image code presented in the meeting room. The acquisition unit 72 captures an image code. The image code is printed in advance from the printer using, for example, the meeting room setting information stored in the meeting management server 30. The image code is affixed near the door of the meeting room or placed on a desk in the meeting room. The image code may be displayed on the display. For example, the electronic device 70 (electronic whiteboard, projector) may display the mage code. Alternatively, the image code may be displayed on electronic paper. In these cases, printing of the image code becomes unnecessary.

In steps S13 and S14, the decoding unit 73 acquires the image code and restores the meeting room information. That is, the meeting room ID, the authentication key, and the email address of the meeting room are generated. If the meeting room information is encrypted, the meeting room information is decrypted. By encrypting the meeting room information, a terminal device 60 where the meeting application 60b is not operating can be prevented from connecting to the meeting management server 30 even if the image code is acquired.

In step S15, in order to connect to the meeting management server 30, the reservation information request unit 74 further acquires the user ID 791 from the storage unit 79.

In step S16, the reservation information request unit 74 designates the meeting room ID, the authentication key, the meeting room email address, and the user ID and requests the reservation information of the meeting room in which the image code is presented from the meeting management server 30 for through the server communication unit 65.

In step S17, the reception unit 31b of the meeting management server 30 receives the request for reservation information. First, the authentication key verification unit 41 determines whether or not the authentication key stored in the meeting room setting information DB 498 designated by the meeting room ID matches the transmitted authentication key. Here, it is assumed that the authentication keys match. Further, authentication by email address may be performed.

Next, the usage management unit 38 determines whether or not check-in is possible. This is because the user of the meeting room not only wants to confirm the reservation information but also often wants to check-in. As described below, in a second embodiment, the meeting management server 30 may return only the reservation information without performing the check-in process. The usage management unit 38 searches the meeting management information DB 493 with the meeting room ID transmitted from the terminal device 60 and determines whether or not there is reservation information whose status is “waiting for check-in”. If reservation information with status “waiting for check-in” is found, the usage management unit 38 determines whether or not the user ID transmitted from the terminal device 60 is included in the reservation-making user account or the expected participant account of the reservation information. If the reservation-making user account or the expected participant account includes the user ID transmitted from the terminal device 60, the usage management unit 38 permits check-in. Therefore, the status becomes “checked-in”.

In step S18, regardless of the result of step S17, (if the reservation-making user account or expected participant account does not include the user ID sent from the terminal device 60 after check-in, or if the status is not “waiting for check-in”), the reservation information transmission unit 44 masks information related to users other than the current user with respect to the reservation information of the meeting room identified by the meeting room ID. Mask refers to processing into an unreadable state. For the reservation information in which the reservation-making user account or the expected participant account does not include the user ID transmitted from the terminal device 60, the reservation information transmission unit 44; -replace the meeting name with a general term such as “meeting”; and -delete the name of the reservation-making user or the name of the expected participant. As a result, it is possible to prevent an unspecified number of people from seeing the reservation information (meeting name, reservation-making user name, participant name) of the meeting room.

In step S19 the transmission unit 31a of the meeting management server 30 transmits the masked reservation information to the terminal device 60.

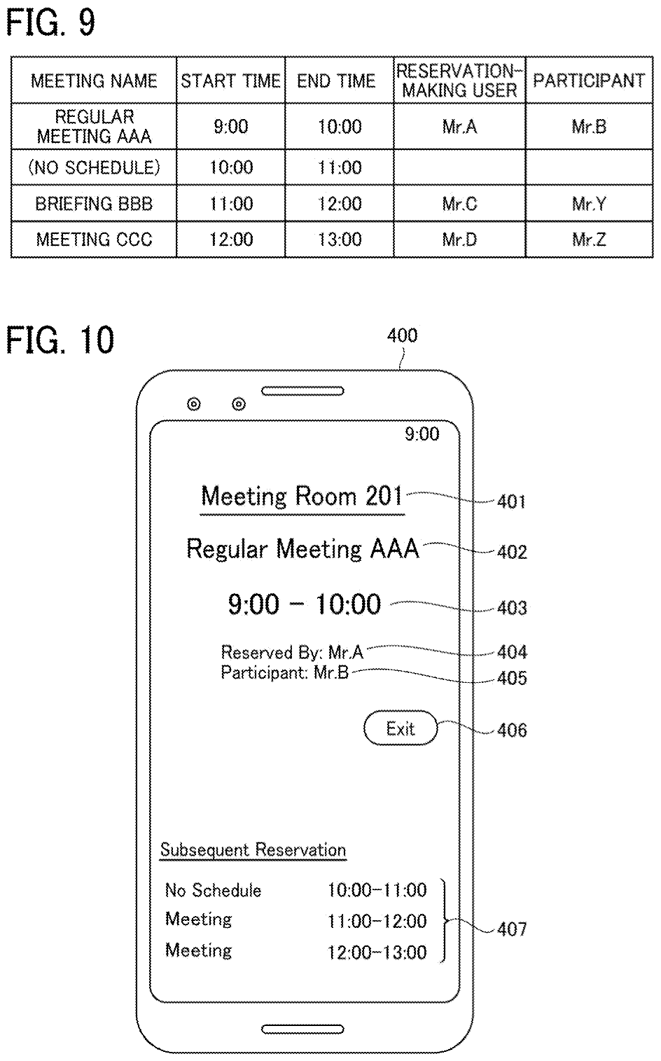

In step S20, the server communication unit 65 of the terminal device 60 receives the reservation information and the display control unit 66 displays the reservation information on the display. FIG. 9 illustrates an example of the reservation information displayed by the terminal device 60.

In step S21, there may be no reservation in the meeting room where the image code is presented (there is no reservation at the current time and the next reservation is not “waiting for check-in”). For example, when the user wants to check the reservation status of the meeting room. In this case, the display control unit 66 of the terminal device 60 displays the “use now” button together with the reservation information. The “use now” button is a button for the user to reserve an empty meeting room for a certain period of time (30 to 60 minutes) from the current time. The certain period of time may be limited by the start time of the next meeting.

When the user presses the “use now” button, the operation reception unit 69 receives the pressing.

In step S22, the reservation request unit 76 of the terminal device 60 makes a reservation request to the reservation management server 20 by designating the user ID, the meeting room ID, and the meeting time through the server communication unit 65. The user ID is stored in the storage unit 79, the meeting room ID is decoded from the image code, and the meeting time may be start time=current time, end time=current time+30 to 60 minutes.

In step S22, the terminal device 60 directly requests the reservation management server 20 to make a reservation, but the reservation may be made through the meeting management server 30. When the reservation is made directly to the reservation management server 20, the reservation-making user becomes the user, and when the reservation is made through the meeting management server 30, the meeting management server 30 becomes the reservation-making user.

In step S23, the communication unit 21 of the reservation management server 20 receives the reservation request, and the reservation information management unit 22 sets the reservation information (meeting room ID, reservation-making user account, start time, end time) in the reservation information DB 291.

In step S24, since the reservation information has been updated, the communication unit 21 of the reservation management server 20 transmits the latest reservation information to the meeting management server 30. The reservation information also includes the reservation information reserved by clicking the “use now” button.

In step S25, the usage request unit 75 of the terminal device 60 designates the meeting room ID, the authentication key, the email address of the meeting room, and the user ID, and transmits the check-in request to the meeting management server 30. The email address may not be included in the check-in request. This check-in request may be made without user's operation.

In step S26, the reception unit 31b of the meeting management server 30 receives the reservation information from the reservation management server 20 and receives the check-in request from the terminal device 60. The usage management unit 38 changes the status of the reservation information to “waiting for check-in” based on the current time and the start time of the meeting. If the authentication by the authentication key is successful, the usage management unit 38 permits check-in to the reservation information identified by the meeting room ID transmitted from the terminal device 60. In this case, the reservation information is masked based on the user ID, as in step S18.

In step S27, the transmission unit 31a of the meeting management server 30 transmits the reservation information to the terminal device 60.

In this way, the user connects to the meeting management server 30 from the terminal device 60, displays the reservation information, and checks in.

The reservation information displayed by the terminal device 60 described with reference to FIGS. 9 to 13. FIG. 9 illustrates the reservation information stored in the meeting management information DB 493 by the meeting management server 30. The case where the terminal device 60 displays this reservation information is described.

FIG. 10 is a diagram illustrating a reservation information screen 400 in which the same user as a reservation-making user displays the reservation information of FIG. 9. The reservation information screen 400 includes a meeting room name 401, a meeting name 402, a meeting time 403, a reservation-making user name 404, a participant name 405, and a subsequent reservation column 407.

The situation in which the screen of FIG. 10 is displayed is when Mr. A captured an image code at 9:00. According to FIG. 9, since Mr. A is the reservation-making user of the “regular meeting AAA”, the reservation information transmission unit 44 transmits the meeting name 402, the reservation-making user name 404, and the participant name 405 without masking. The meeting time 403 (start time and end time) is displayed regardless of the user.

The terminal device 60 displays the next and subsequent reservation information of the same meeting room in the subsequent reservation column 407. The reservation information transmission unit 44 refers to the reservation information after the “regular meeting AAA” in FIG. 9, but the reservation information transmission unit 44 determines that Mr. A is neither a reservation-making user nor a participant of the reservation information other than the “regular meeting AAA”. Therefore, change (mask) the meeting name of “briefing BBB” and “meeting CCC” to “meeting”.

In addition, Mr. A is a reservation-making user for the “regular meeting AAA”, and since this reservation information is “waiting for check-in” in terms of time, the usage management unit 38 automatically permits check-in when the image code is captured. When the usage management unit 38 transmits “checked-in” or the like to the terminal device 60, the display control unit 66 of the terminal device 60 displays the “exit” button 406. The “exit” button 406 is a button for the user to check-out.

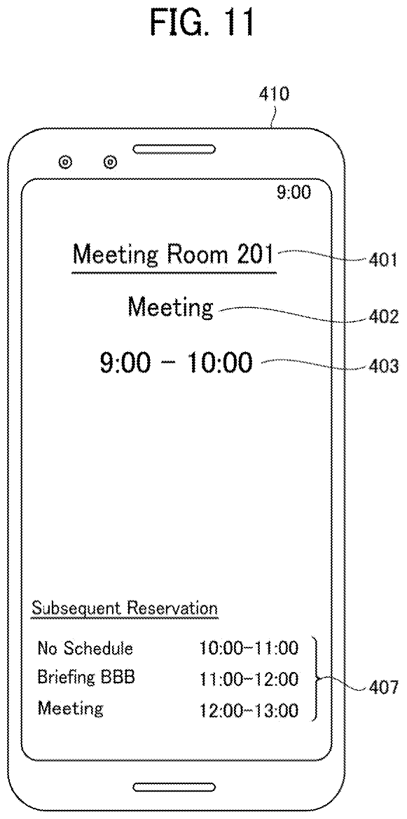

FIG. 11 is a diagram illustrating the reservation information screen 410 in which a user different from the reservation-making user or a participant displays the reservation information of FIG. 9. The situation in which the screen of FIG. 11 is displayed is when Mr. C captures an image code at 9:00. According to FIG. 9, since Mr. C is neither a reservation-making user nor a participant of the “regular meeting AAA”, the reservation information transmission unit 44 deletes the meeting name 402, the reservation-making user name 404, and the participant name 405, and change the meeting name “regular meeting AAA” to “meeting”. In alternative to deleting, the reservation information may be made unreadable.

Regarding the subsequent reservation column 407, the reservation information transmission unit 44 refers to the reservation information after the “regular meeting AAA” in FIG. 9 and determines that Mr. C is the reservation-making user for the “briefing BBB”, but neither the reservation-making user nor the participant of the “meeting CCC”. Therefore, the meeting name “briefing BBB” is not masked, and the meeting name “meeting CCC” is changed (masked) to “meeting”.

In addition, since Mr. C is not the reservation-making user of the “regular meeting AAA”, the usage management unit 38 does not permit check-in when the image code is captured. Therefore, the display control unit 66 of the terminal device 60 does not display the “exit” button.

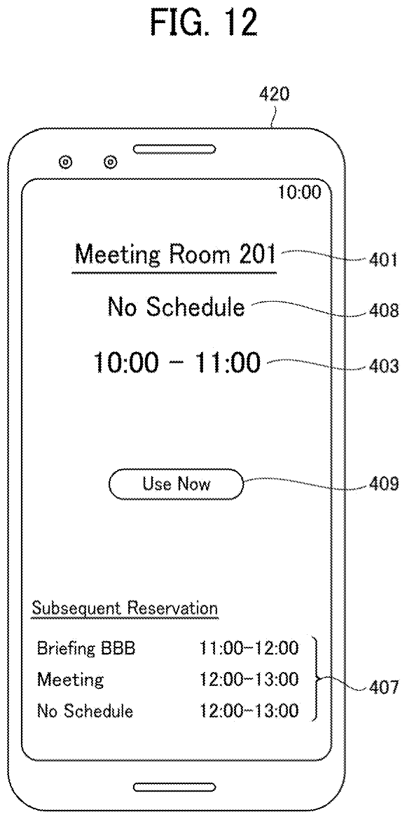

FIG. 12 is a diagram illustrating the reservation information screen 420 in which a user displays the reservation information of FIG. 9 when the meeting room is not reserved. The situation in which the reservation information of FIG. 12 is displayed is when Mr. C captures the image code at 10:00. According to FIG. 9, since there is no schedule in the meeting room at 10:00, the reservation information transmission unit 44 sets “no schedule” 408 instead of the meeting name 402.

Regarding the subsequent reservation column 407, the reservation information transmission unit 44 refers to the reservation information after the “no schedule” in FIG. 9 and determines that Mr. C is the reservation-making user for the “briefing BBB”, but neither the reservation-making user nor the participant of the “meeting CCC”. Therefore, the meeting name “briefing BBB” is not masked, and the meeting name “meeting CCC” is changed (masked) to “meeting”.

When this reservation information is transmitted to the terminal device 60, since there is no schedule in the meeting room (there is no reservation at the current time and the status of the next reservation is not “waiting for check-in”), the display control unit 66 displays the “use now” button 409. When the “use now” button 409 is pressed, the meeting name may be “meeting” or the like.

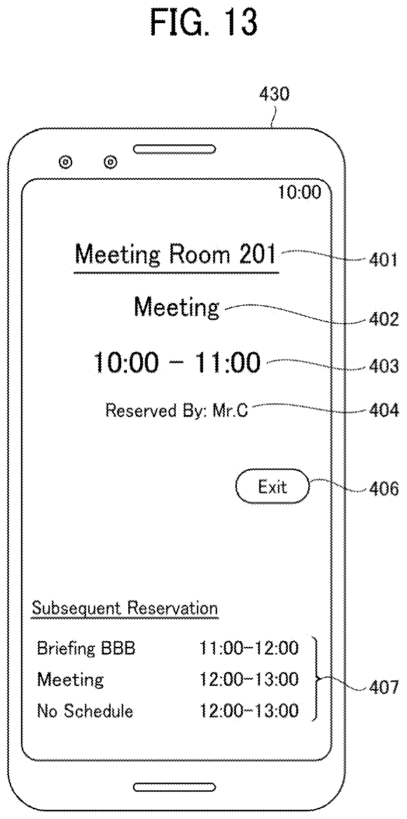

FIG. 13 is a diagram illustrating an example of the reservation information screen 430 displayed by the terminal device 60 when “use now” button 409 is pressed. Since Mr. C made a reservation, the name of the reservation-making user is “Mr. C”. Also, the meeting name is the default “meeting”. In addition, since the reservation-making user and Mr. C who captured the image code match, check-in is automatically performed. Since “checked-in” is transmitted to the terminal device 60, the display control unit 66 displays the “exit” button 406. The subsequent reservation column 407 is the same as in FIG. 12.

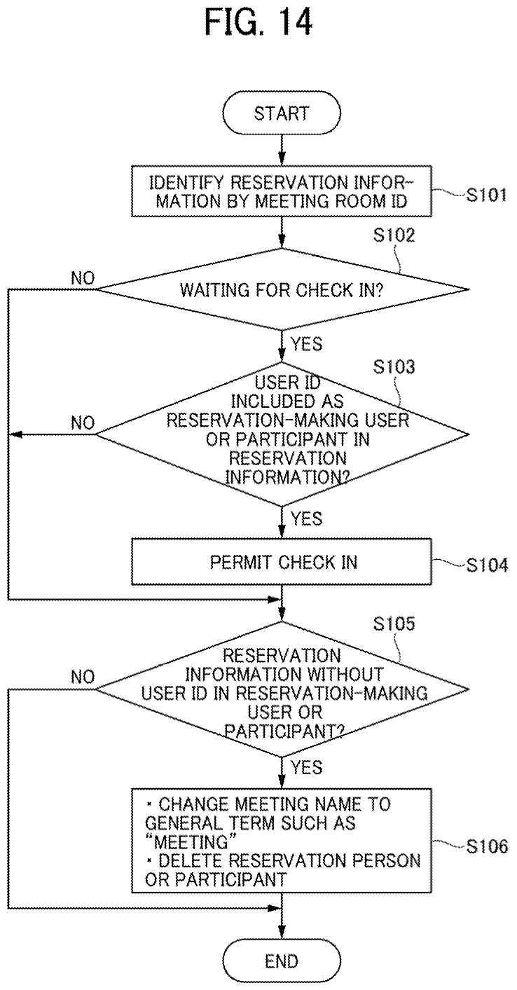

FIG. 14 is a flowchart illustrating an example of a process of the meeting management server 30. The process of FIG. 14 starts when the meeting management server 30 receives a request for reservation information (meeting room ID, authentication key, meeting room email address, and user ID). In the present embodiment, a request for reservation information may also serve as a check-in request.

In step S101, the usage management unit 38 identifies the reservation information in the meeting management information DB 493 by the meeting room ID transmitted from the terminal device 60.

In step S102, the usage management unit 38 determines whether or not the status of one or more identified reservation information is “waiting for check-in”.

When there is reservation information with status “waiting for check-in”, the usage management unit 38 determines whether or not the reservation-making user or participant of the identified reservation information includes the user ID transmitted from the terminal device 60 in step S103.

If the determination in step S103 is Yes, the usage management unit 38 permits check-in in step S104. Accordingly, the usage management unit 38 updates the status of the reservation information to “checked-in”.

Next, the reservation information transmission unit 44 acquires the reservation information of the meeting room of the meeting room ID transmitted from the terminal device 60 after the current time from the meeting management information DB 493. Then, in step S105, for each reservation information, the reservation information transmission unit 44 determines whether or not the user ID transmitted from the terminal device 60 is included as the reservation-making user or the participant.

If the user ID transmitted from the terminal device 60 is not included, the reservation information transmission unit 44 replaces the meeting name with a general term such as “meeting” and deletes the reservation-making user name or the participant name in step S106.

As a result, it is possible to prevent an unspecified number of people from seeing the reservation information (meeting name, reservation-making user name, participant name) of the meeting room.

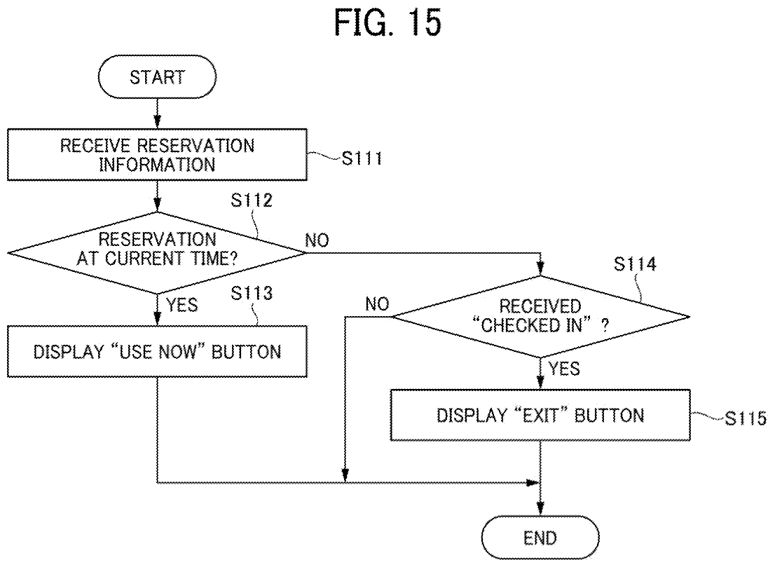

FIG. 15 is a flowchart illustrating an example of a process in which a terminal device 60 displays the reservation information.

In step S111, the server communication unit 65 of the terminal device 60 receives the reservation information. In step S112, the display control unit 66 determines whether or not there is a reservation for the current time. Specifically, the display control unit 66 determines whether or not there is a reservation at the current time and the status of the next reservation is not “waiting for check-in”. Alternatively, the display control unit 66 may determine if there is reservation information with the status of “waiting for check-in”.

If there is no reservation at the current time, the display control unit 66 displays the received reservation information and displays the “use now” button in step S113.

If there is reservation information for the current time, the display control unit 66 determines whether or not the status “checked-in” has been received in step S114.

When the status “checked-in” has been received, the display control unit 66 displays the received reservation information and displays the “exit” button in step S115.

As a result, the terminal device 60 displays only appropriate buttons.

Although the terminal device 60 controls the display of the buttons in FIG. 15, when the terminal device 60 displays the reservation information by the web browser instead of the meeting application 60b, the processing of FIG. 15 is performed by the meeting management server 30.

As described above, in the resource reservation system 100 of the present embodiment, the terminal device 60 acquires the meeting room information by capturing the image code. Since the terminal device 60 can display the reservation information and perform check-in and check-out to the meeting management server 30, the meeting room terminal is not required for each meeting room. Since the meeting room terminal is not required for the meeting room, the burden of system construction and management operation can be reduced.

Further, since the meeting room can be used by the terminal device 60 that has been authenticated by the user, the user identification information and the reservation information that identifies the user can be stored and utilized. For example, the reservation information for each user can be shared to inform a boss or a colleague who is associated with the user's information about who is where and when. In addition, since the meeting room terminal 90 does not display the reservation information and the terminal device 60 also masks the reservation information it is possible to prevent an unspecified number of people from seeing the reservation information (meeting name, reservation-making user name, participant name) of the meeting room.

Further, as described above in the present embodiment, the user checks in with the user-authenticated terminal device 60, but the terminal device 60 may simply request check-in by capturing an image code in status where the user is not authenticated. In this case, the user is not identified, but if the meeting room is vacant, the meeting management server 30 may allow the use of the meeting room, for example, for one hour. In this case, the meeting management server 30 may store reservation information only as to whether or not the meeting room reservation is filled, regardless of who the user is.

In the second embodiment, the resource reservation system 100 that can use or reserve a meeting room different from the meeting room in which the image code is presented from the terminal device 60 is described.

In the present embodiment, the hardware configuration diagrams of FIGS. 4 and 5 and the functional block diagrams illustrated in FIGS. 6A, 6B, 7A, and 7B described in the above embodiment is described as being applicable.

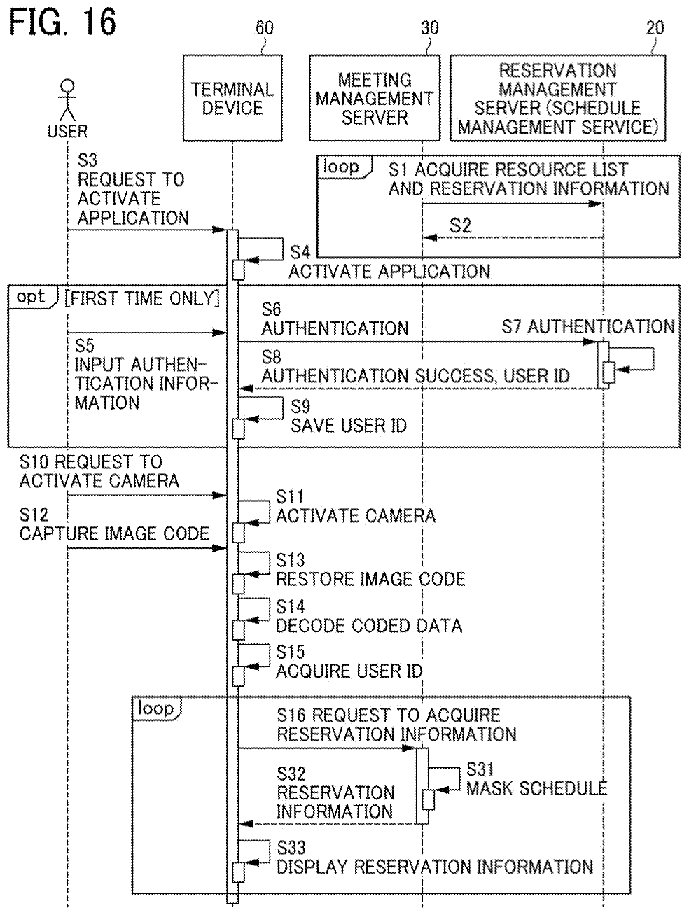

The process until the terminal device 60 displays the reservation information is described with reference to FIG. 16. FIG. 16 is a sequence diagram illustrating an operation of the resource reservation system according to a second embodiment of the present disclosure. In the description of FIG. 16, differences from FIG. 8 is mainly described. The processing of steps S1 to S16 may be the same as in FIG. 8.

In the present embodiment, the usage management unit 38 does not check-in in response to the reservation information acquisition request, and in step S31, the reservation information transmission unit 44 transmits the reservation information (an example of the second reservation information). The method of masking the reservation information may be the same as in the first embodiment. Further, the reservation information transmission unit 44 of the present embodiment extracts the past reservation information in which the user ID included in the image code is included in the reservation-making user account or the participant account from the meeting management information DB 493. Then, the meeting room ID is acquired from this reservation information. That is, the reservation information transmission unit 44 identifies a meeting room that the user has used in the past. Note that, not all the meeting rooms that the user has used may be identified, but the meeting rooms that have been used retroactively for a certain period of time may be identified, or the meeting rooms that have been used more than a certain number of times may be identified.

As a result, the user can check-in or reserve a meeting room other than the meeting room in which the image code is presented from the terminal device 60. The reservation information transmission unit 44 also performs mask processing on the reservation information (an example of the first reservation information) of the meeting room that the user has used since the present time.

In step S32, the transmission unit 31a of the meeting management server 30 transmits the reservation information of the meeting room in which the image code is presented and the meeting room that the user has used to the terminal device 60.

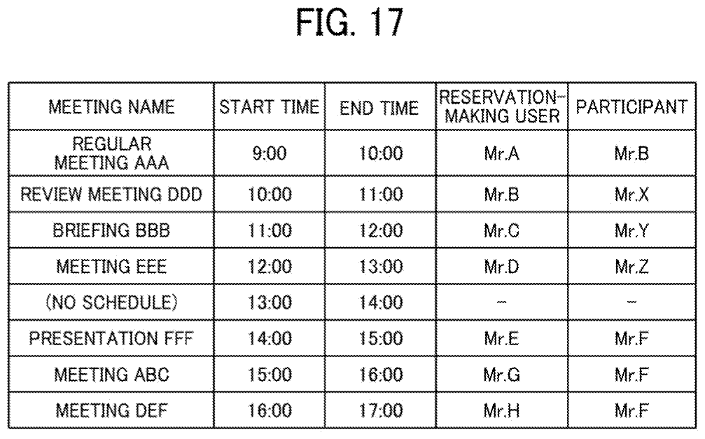

In step S33, the server communication unit 65 of the terminal device 60 receives the reservation information, and the display control unit 66 displays the reservation information. An example of the reservation information displayed by the terminal device 60 is illustrated in FIG. 17 and the like. The display control unit 66 switches the display of the first reservation information and the second reservation information according to the operation of the user.

The reservation information displayed by the terminal device 60 in the present embodiment is described with reference to FIGS. 17 to 21. FIG. 17 is a diagram illustrating an example of the reservation information stored in the meeting management information DB 493 by the meeting management server 30. The case where the terminal device 60 displays the reservation information is described.

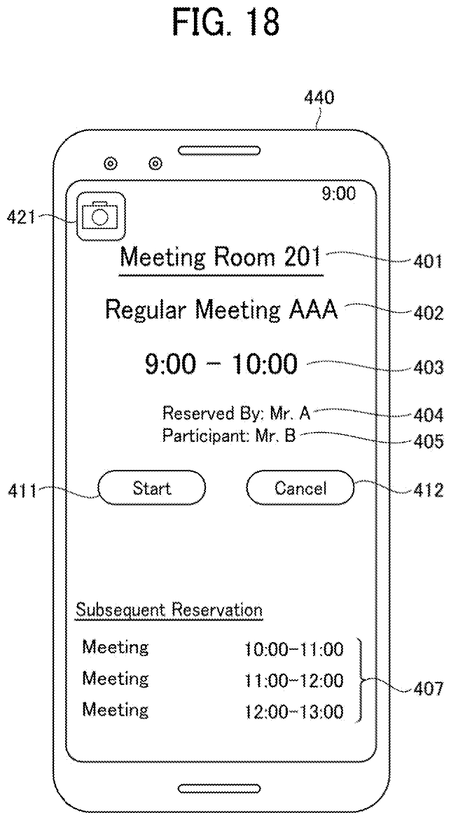

FIG. 18 is a diagram illustrating an example of the reservation information screen 440 of meeting room 201 displayed on the terminal device 60 by Mr. A. Similar to the first embodiment, since Mr. A is a reservation-making user for the “regular meeting AAA”, the terminal device 60 displays the meeting name 402, the reservation-making user name 404, and the participant name 405.

Further, in the present embodiment, since the usage management unit 38 has not yet performed the check-in process, the display control unit 66 of the terminal device 60 displays the “start” button 411 to start using the meeting room (check-in) and the “cancel” button 412 for canceling the reservation. Specifically, since the reservation-making user name of the reservation information of the “regular meeting AAA” and the user ID of the storage unit 79 match and since the terminal device 60 received “waiting for check-in”, the display control unit 66 displays the “start” button 411 and the “cancel” button 412.

The method of creating the subsequent reservation column 407 is the same as in the first embodiment. Since Mr. A is neither a reservation-making user nor a participant of reservation information other than “regular meeting AAA”, the meeting name is masked as “meeting”.

Further, the reservation information screen 440 includes a camera icon 421. When the user presses the camera icon 421, the terminal device 60 activates the camera (CMOS). Therefore, the user can capture the image code presented in another meeting room while the reservation information screen 440 is displayed.

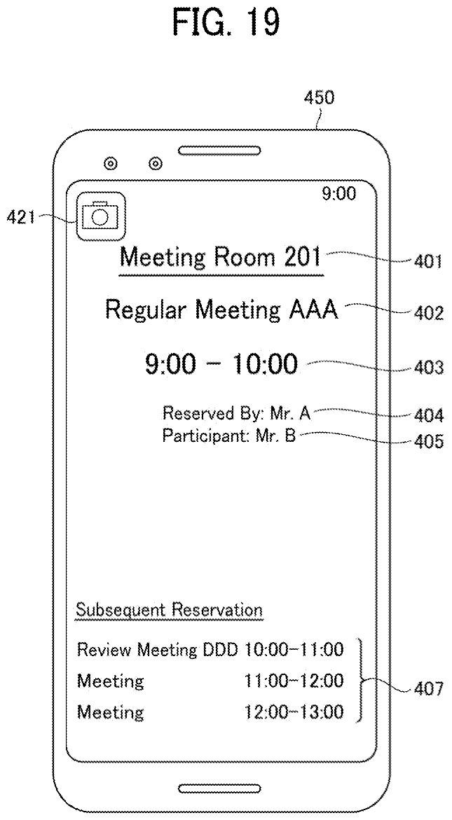

FIG. 19 is a diagram illustrating an example of the reservation information screen 450 of the meeting room 201 displayed on the terminal device 60 by Mr. B. Since Mr. B is a participant of the “regular meeting AAA”, the terminal device 60 displays the meeting name 402, the reservation-making user name 404, and the participant name 405. However, since Mr. B is not the reservation-making user for the “regular meeting AAA”, the display control unit 66 does not display the “start” button and the “cancel” button even before check-in. The display control unit 66 performs the above described control by comparing the user ID of the storage unit 79 with the reservation-making user name. However, the “start” button and the “cancel” button may be displayed to the participants as well. Alternatively, only one of the “start” button and the “cancel” button may be displayed.

Further, in the subsequent reservation column 407, since Mr. B is the reservation-making user of the “review meeting DDD”, the reservation information transmission unit 44 does not mask the meeting name only for this schedule, and other meeting names are masked as “meeting”.

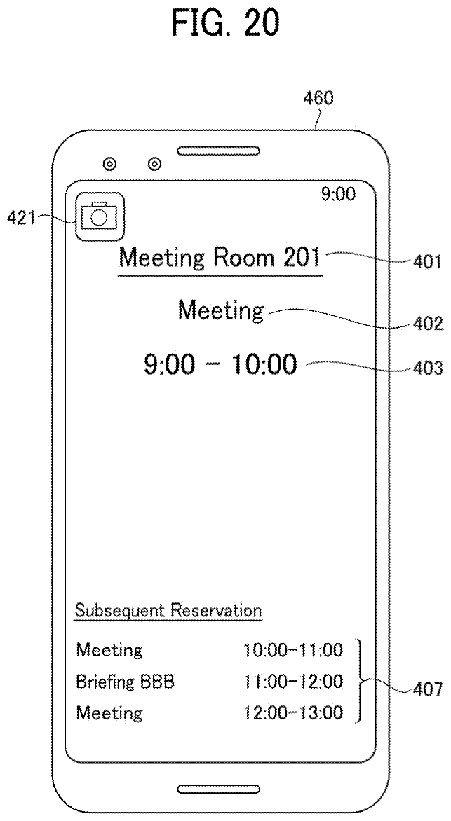

FIG. 20 is a diagram illustrating an example of the reservation information screen 460 of the meeting room 201 displayed on the terminal device 60 by Mr. C. Since Mr. C is neither a reservation-making user nor a participant of the “regular meeting AAA”, the reservation information transmission unit 44 masks the meeting name as “meeting”. Also, the reservation-making user name and the name of the participant are deleted.

In the subsequent reservation column 407, since Mr. C is the reservation-making user for “briefing BBB”, the reservation information transmission unit 44 does not mask the meeting name of the reservation information, and for other meetings that Mr. C is neither reservation-making user nor participant, mask the meeting name as “meeting”.

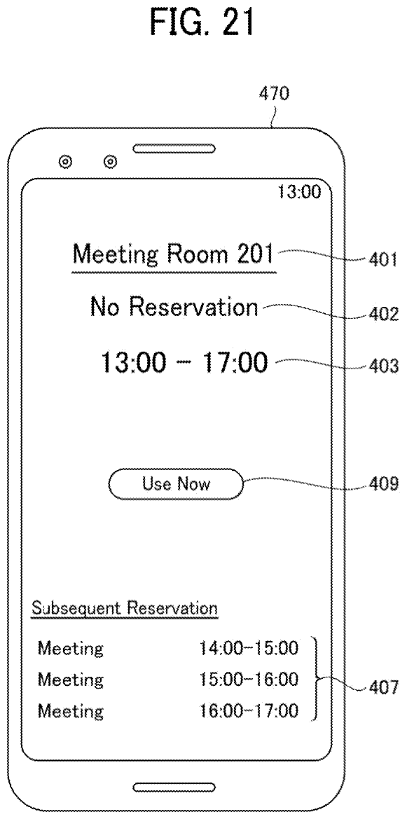

FIG. 21 is a diagram illustrating an example of the reservation information screen 470 of the meeting room 201 displayed by the terminal device 60 when Mr. A captured the image code at 13:00. According to FIG. 17, since the meeting room is not reserved at 13:00, the reservation information transmission unit 44 sets “no schedule” instead of the meeting name.

Regarding the subsequent reservation column 407, the reservation information transmission unit 44 refers to the reservation information after “(no schedule)” in FIG. 17, but since Mr. A is neither a reservation-making user nor a participant of the subsequent meetings, the reservation information transmission unit 44 masks the meeting name as “meeting”.

When this reservation information is transmitted to the terminal device 60, since there is no schedule in the meeting room (there is no reservation at the current time and the status of the next reservation is not “waiting for check-in”), the display control unit 66 displays the “use now” button 409.

An image code of a meeting room that the user has not reserved may'be captured accidentally. Alternatively, an image code of any meeting room may be captured to confirm the reservation status. In these cases, the terminal device 60 displays a screen on which the user cannot check-in, for example, as illustrated in. FIG. 20. In general, if the user can check-in anywhere, empty reservations become difficult to prevent. Therefore, in the resource reservation system 100 of the present embodiment, the resource reservation system 100 assumes that the user is in the meeting room by the user capturing the image code presented in the meeting room, and check-in is permitted. However, even though the meeting room has not been reserved by the user, if the user is actually in a meeting room, assuming that the user does not intend to make an empty reservation, convenience will be improved by relaxing the conditions for check-in.

Therefore, in the present embodiment, if the meeting room used in the past by the terminal device 60, the usage management unit 38 permits check-in even when the image code of the meeting room that has not been reserved is captured.

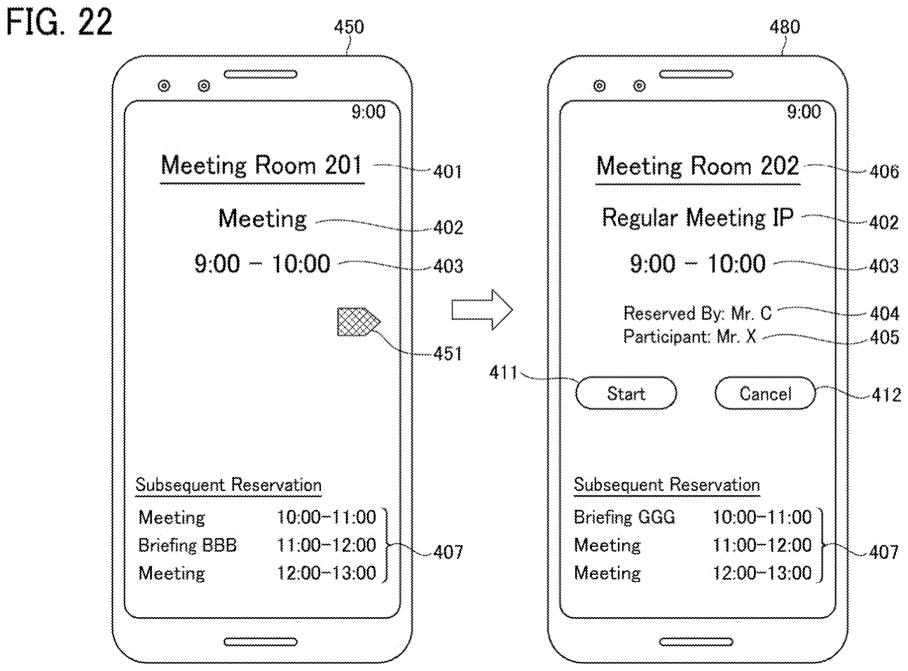

FIG. 22 illustrates a reservation information screen 480 of another meeting room transitioning from the screen of FIG. 20. The user is Mr. C. The reservation information screen 450 in FIG.22 is the same as the reservation information screen 460 in FIG. 20. On the reservation information screen 450 of FIG. 22, when the reservation information of the meeting room other than the meeting room 201 is transmitted, the display control unit 66 displays a swipe button 451. Whether or not there is reservation information for another meeting room is determined by the meeting room ID. Mr. C presses the swipe button 451 to display reservation information for another meeting room, since the “start” button etc. for the meeting room that Mr. C reserved is not displayed, and since the meeting room name (meeting room 201) different from the meeting room Mr. C reserved is displayed.

As a result, the reservation information screen 480 of FIG. 22 is displayed. On the reservation information screen 480 of FIG. 22, since the reservation-making user and the user ID match, the meeting name 402, the reservation-making user name 404, and the participant name 405 are displayed. Further, the “start” button 411 and the “cancel” button 412 are displayed. Therefore, Mr. C can check-in to the meeting room 202.

As described above, the meeting management server 30 transmits the reservation information of the meeting room other than the meeting room in which the user has captured the image code. The user can check in without having to capture the image code of the meeting room newly reserved by the user.

When a user wants to use a meeting room immediately, but the meeting room reservation is full, or when the user have reserved a meeting room but wants to change the meeting room due to the number of people and equipment, the user can reserve or change to another meeting room.

Since the meeting room is identified by capturing the image code, convenience is improved if the user can reserve the meeting room in which the image code is presented by designating a time of user's choice. With the “use now” button, a reservation can be made for a certain period of time from the current time. Regardless of what kind of reservation information is displayed or the usage status (whether checked-in or not), the user can reserve a new meeting room from the reservation information screen.

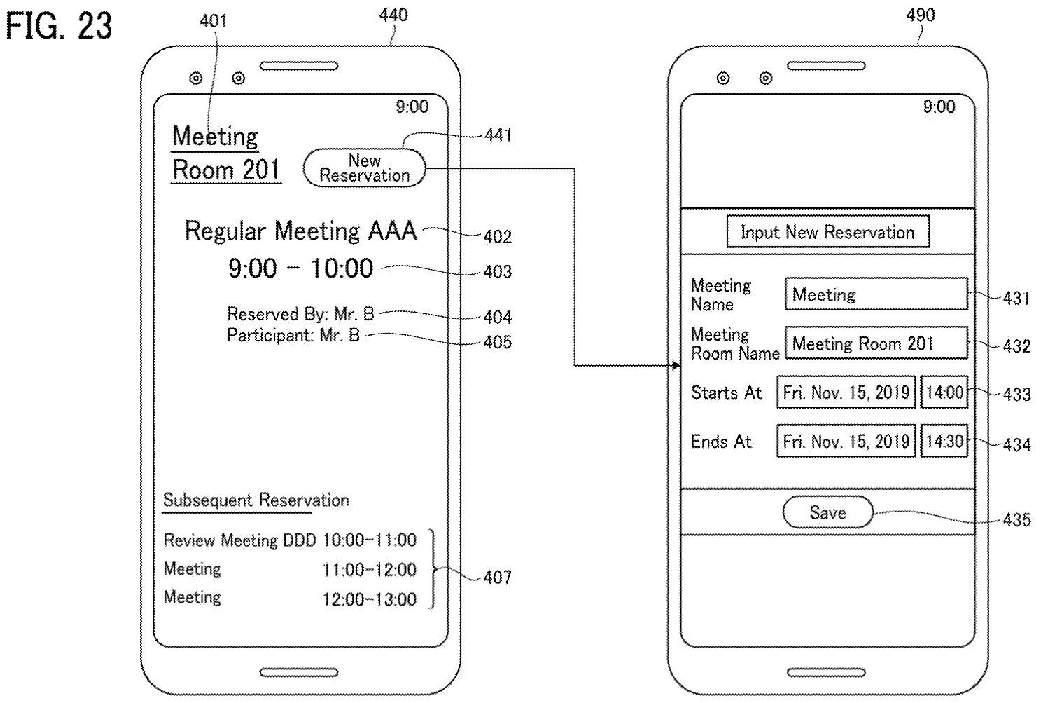

FIG. 23 is a diagram illustrating an example of a new reservation screen 490 transitioned from the reservation information screen 440 of FIG. 18. The reservation information screen 440 of FIG. 23 includes a “new reservation” button 441. When the user presses the “new reservation” button 441, the reservation information screen 440 transitions to the new reservation screen 490 of FIG. 23. This transition is possible regardless of the displayed reservation status (meeting name, reservation-making user name, participant name, presence or absence of various buttons) and usage status (checked-in or not).

The new reservation screen 490 includes input fields of a meeting name 431, a meeting room name 432, a start time 433, and an end time 434. The new reservation screen 490 may be generated by the meeting management server 30 or the meeting application 60b. In the present embodiment, the meeting management server 30 generates the new reservation screen 490. The meeting management server 30 sets the meeting room name in which the image code is presented in the meeting room name input field 432. The user sets values for the meeting name input field 431, the start time input field 433, and the end time input field 434. Regarding the start time input field 433 and the end time input field 434, it is preferable that the meeting management server 30 transmits the time slot that is already reserved to the terminal device 60. By controlling the terminal device 60 not to accept the reservation avoiding already reserved time slot, the user can reserve the meeting room when reservation has not been made.

When the user inputs the reservation information and presses the “save” button 435, the server communication unit 65 sends the reservation request to the reservation management server 20, so that the reservation can be confirmed.

As described above, the user can reserve a new meeting room from the reservation information screen.

If the user can reserve a meeting room other than a meeting room in which the image code is presented on the new reservation screen, the convenience will be further improved. In this case, the meeting management server 30 may provide the terminal device 60 with the reservation information of the meeting room other than the meeting room in which the user has captured the image code, depending on the current meeting room in which the image code is captured or a location of the user. The location of the user refers to the location of the meeting room, but if the meeting management server 30 can detect the location of the user by Global Positioning System (GPS) (Global Navigation Satellite System (GNSS)) or the like, a meeting room close to the user can be presented. The meeting management server 30 (resource management server) may search for a resource at a location close to the user's terminal device using GPS and present the resource to the terminal device. In this case, if the resource is an outdoor resource (company car, parking lot, building itself, etc.) or a meeting room or space in an one-floor office, a search using GPS is preferable compared to a meeting room in a multiple floor office. Further, in the case of a meeting room in the multiple floor office, the location may be identified by wireless communication and GPS may be combined to search for nearby resources and improve the search accuracy.

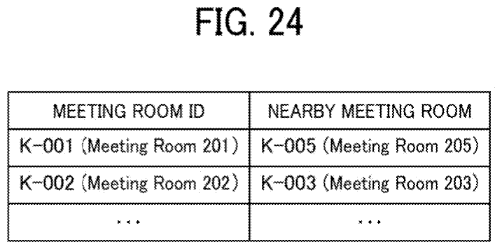

Therefore, in the present embodiment, as illustrated in FIG. 24, the meeting management server 30 stores the information of the nearby meeting room in the storage unit 49. FIG. 24 is a diagram illustrating an example of meeting room arrangement information. The meeting room arrangement information includes the meeting room ID of the meeting room within a certain distance from each meeting room. The meeting management server 30 transmits the meeting room ID of the meeting room close to the meeting room in which the user has captured the image code to the terminal device 60 together with the reservation information.

When the user presses the new reservation button 441 on the reservation information screen 440, the new reservation screen 490 displays the meeting room in which the user has captured the image code and the nearby meeting room in a selectable manner.

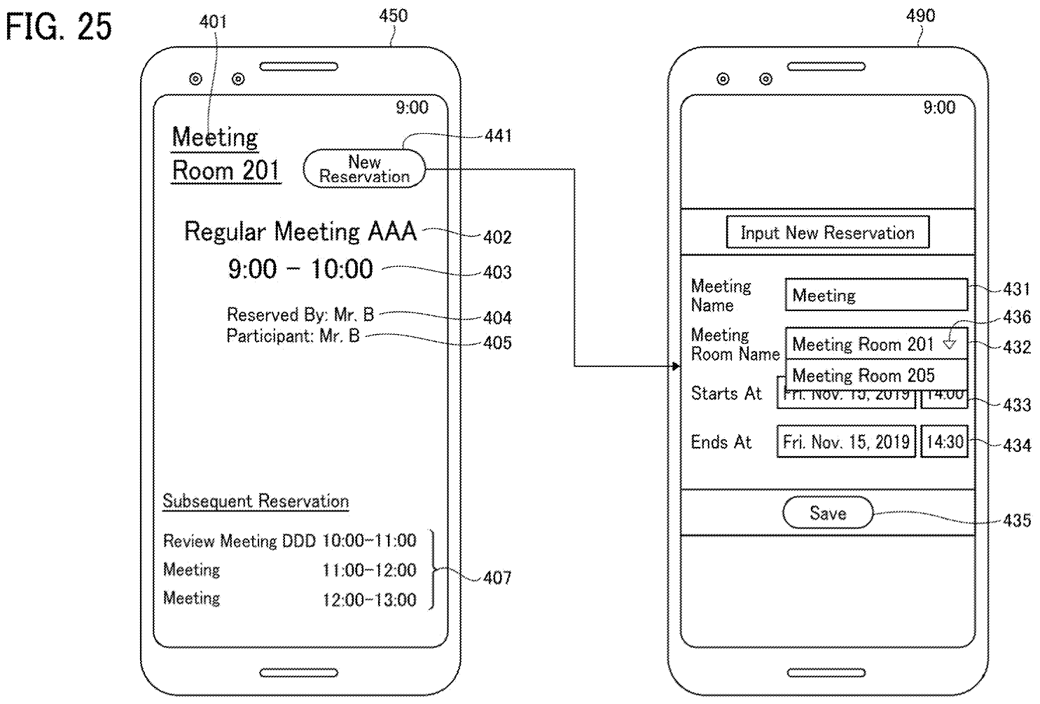

FIG. 25 is a diagram illustrating an example of a new reservation screen for displaying a plurality of meeting rooms in a selectable manner. FIG. 25 is the same as FIG. 23, but the meeting room name input field 432 of the new reservation screen 490 includes a pull-down menu 436. When the user presses the pull-down menu 436, the meeting room in which the image code is captured, and the nearby meeting room are displayed.

The pull-down menu 436 may display a meeting room that the user has used.

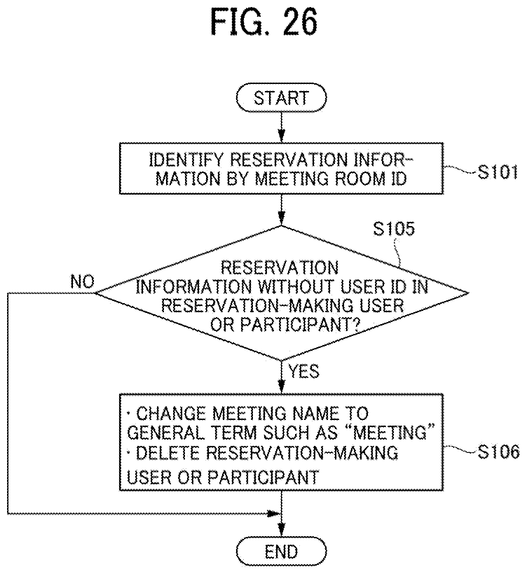

FIG. 26 is a flowchart illustrating an example of a process executed by the meeting management server. In the present embodiment, check-in is not performed, so the difference is that steps S102 to S104 in FIG. 14 are not provided.

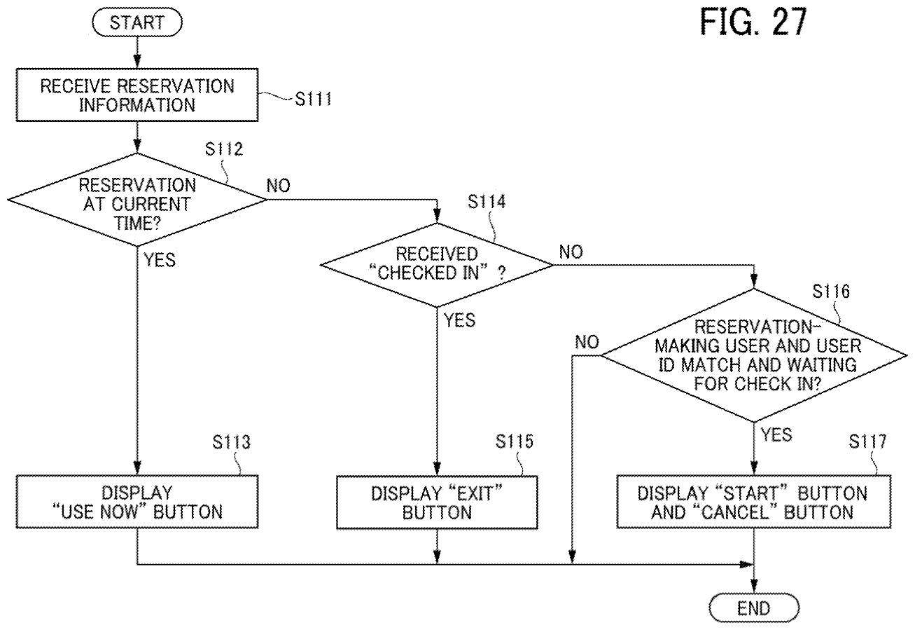

FIG. 27 is a flowchart illustrating an example of a process in which a terminal device 60 displays the reservation information. The processing of steps S111 to S115 is the same as in FIG. 26.

When the “checked-in” is not received in step S114, the display control unit 66 determines whether the reservation-making user and the user ID of the storage unit 79 match and whether the status of the reservation information is “waiting for check-in” in step S116.

If the determination in step S116 is Yes, the display control unit 66 displays a “start” button and a “cancel” button in step S117.

By doing so, the terminal device 60 can display appropriate buttons.

In FIG. 27, the terminal device 60 controls the display of the buttons, but when the terminal device 60 displays the reservation information by the web browser instead of the meeting application 60b, the processing of FIG. 27 is performed by the meeting management server 30.

As described above, in the resource reservation system 100 of the present embodiment, the terminal device 60 acquires the meeting room information by capturing the image code. Since the terminal device 60 can display the reservation information and perform check-in and check-out to the meeting management server 30, the meeting room terminal is not required for each meeting room. Since the meeting room terminal is not required for the meeting room, the burden of system construction and management operation can be reduced.

Further, since the meeting room can be used by the terminal device 60 that has been authenticated by the user, the user identification information and the reservation information that identifies the user can be stored and utilized. For example, the reservation information for each user can be shared to inform the contact information of a boss or a colleague who is associated with the user's information about who is where and when. In addition, since the meeting room terminal 90 does not display the reservation information and the terminal device 60 also masks the reservation information it is possible to prevent an unspecified number of people from seeing the reservation information (meeting name, reservation-making user name, participant name) of the meeting room.

When a user wants to use a meeting room immediately, but the meeting room reservation is full, or when the user have reserved a meeting room but wants to change the meeting room due to the number of people and equipment, the user can reserve or change to another meeting room.

In a third embodiment, a resource reservation system in which the terminal device 60 and the meeting room terminal 90 are both connected to the meeting management server 30 is described.

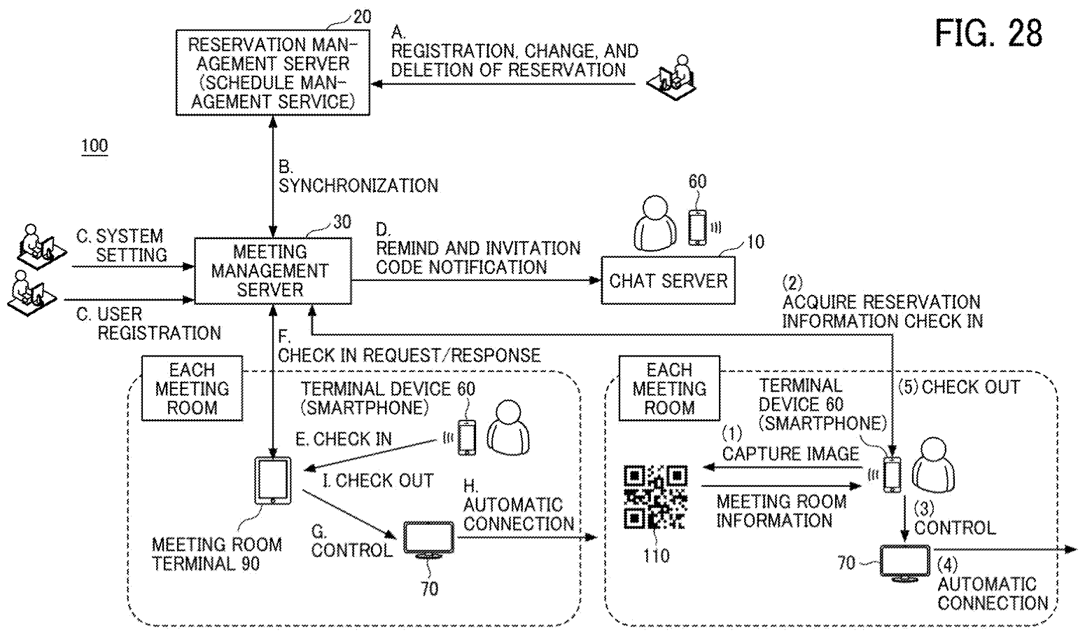

FIG. 28 is a diagram illustrating an example of an outline of the overall operation of the resource reservation system according to the third embodiment. The process until the meeting room terminal 90 connects to the meeting management server 30 (process F) is the same as in FIG. 1, and the process until the terminal device 60 connects to the meeting management server 30 (process (2)) is the same as in FIG. 2.

The meeting management server 30 receives check-in requests from both the meeting room terminal 90 and the terminal device 60 and permits check-in (permits use) when a request is an appropriate check-in request.

That is, the usage management unit 38 of the meeting management server 30 receives the check-in request from each of the terminal device 60 and the meeting room terminal 90. The usage management unit 38 searches the meeting management information DB 493 with the meeting room ID transmitted from the terminal device 60 and determines whether or not there is reservation information whose status is “waiting for check-in”. If reservation information with status “waiting for check-in” is found, the usage management unit 38 determines whether or not the user ID transmitted from the terminal device 60 is included in the reservation-making user account or the expected participant account of the reservation information. When the reservation-making user account or the expected participant account includes the user ID transmitted from the terminal device 60, the usage management unit 38 determines the check-in request from the meeting room terminal 90.

The usage management unit 38 permits check-in when the status of the meeting room identified by the meeting room ID transmitted by the meeting room terminal 90 is “waiting for check-in” and the set of the meeting room ID and the meeting identification information (invitation code) transmitted by the meeting room terminal 90 is registered in the meeting identification information DB 494. Order of the determination of the meeting room terminal 90 and the terminal device 60 may be reversed.

Regarding checkout, the usage management unit 38 may permit check-out when there is a checkout request from both the meeting room terminal 90 and the terminal device 60 and when there is a checkout request from either the meeting room terminal 90 or the terminal device 60.

The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure. Any one of the above-described operations may be performed in various other ways, for example, in an order different from the one described above.

For example, on the reservation information screen, an affiliation name of the reservation-making user may be displayed or masked. In addition, the information to be masked is preferably information that indicates the contents of the meeting and may be personal information such as an icon and contact information.

In addition, the resource reservation system 100 can include a plurality of meeting management servers 30. The meeting management server 30 can be configured as a plurality of servers to which divided functions are arbitrary allocated. The reservation management server 20 and the meeting management server 30 may be implemented by a single entity.

The apparatuses or devices described in the present embodiment are merely one example of plural computing environments that implement one or more embodiments disclosed herein. In some embodiments, meeting management server 30 includes multiple computing devices, such as a server cluster. The plurality of computing devices are configured to communicate with one another through any type of communication link, including a network, shared memory, etc., and perform the processes disclosed herein. Similarly, the meeting room terminal 90 can include a plurality of computing devices configured to communicate with each other.

The resource reservation system 100 of the present embodiment can also be referred to as a “web service”. The web service refers to various services provided by the Internet-related technologies. Examples of the web service include various rental services such as a meeting room rental service. A system that uses the service is called a usage system.

In addition, the functional configuration of the resource reservation system 100 are divided into the functional blocks as illustrated in FIGS. 6A, 6B, 7A, and 7B, for example, based on main functions thereof, in order to facilitate understanding the processes performed by the resource reservation system 100. No limitation is intended by how the processes are divided or by the name of the processes. The resource reservation system 100 can also be divided into the larger number of units according to the processing contents. Further, the processing unit may be divided so that one processing unit includes more processing.

Each function of the embodiments described above can be implemented by one or a plurality of processing circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

What is claimed is:

1. A resource reservation system comprising:
an information processing apparatus including:
first circuitry configured to manage use of resources; and
a terminal device communicable with the information processing apparatus, the terminal device including second circuitry configured to:
acquire resource identification information of each resource that is accessible; and
requests the information processing apparatus to use the resource identified by the acquired resource identification information.

2. The resource reservation system of claim 1, wherein
the second circuitry is further configured to:
acquire user identification information of an authenticated user;
request the information processing apparatus for reservation information of the resource, using the acquired resource identification information, and
the first circuitry is configured to:
when the reservation information of the resource including the resource identification information includes the acquired user identification information, permits the use of the resource reserved by the reservation information of the resource including the resource identification information.

3. The resource reservation system of claim 2, wherein
the first circuitry is configured to:
transmit the reservation information of the resource identified by the resource identification information to the terminal device; and
the second circuitry is further configured to:
display on a display, the reservation information received from the information processing apparatus;
display on the display, a button that instructs start of use together with the reservation information; and
in response to pressing of the button that instructs the start of use, request the information processing apparatus to use the resource.

4. The resource reservation system of claim 3, wherein
when a reservation-making user of the reservation information and a user identified by the user identification information are the same and the reservation information includes a status that indicates use can be started, the second circuitry is configured to display on the display, the button that instructs the start of use together with the reservation information.

5. The resource reservation system of claim 3, wherein
when the first circuitry permits the use of the resource, the second circuitry is configured to display on the display a button to end the use of the resource together with the reservation information.

6. The resource reservation system of claim 3, wherein
when the resource is not reserved when the second circuitry requests the information processing apparatus to use the resource, the second circuitry is configured to display on the display, a button that accepts reservation of the resource.

7. The resource reservation system of claim 3, wherein
the first circuitry is further configured to mask at least a part of the reservation information when none of a reservation-making user and a participant of the reservation information includes the user identified by the user identification information.

8. The resource reservation system of claim 7, wherein
when none of the reservation-making user and the participant of the reservation information includes the user identified by the user identification information, the first circuitry is configured to mask at least one of a meeting name, the reservation-making user, and the participant of the reservation information.

9. The resource reservation system of claim 3, wherein
the first circuitry is further configured to:
identify the resource reserved in past reservation information that includes the user identification information in one of a reservation-making user and a participant; and
transmit first reservation information of the resource and second reservation information of the resource identified by the resource identification information to the terminal device; and
the second circuitry is further configured to switch display of the first reservation information and the second reservation information according to an operation of the user.

10. The resource reservation system of claim 9, wherein
the second circuitry is further configured to:
display on the display a button that accepts a new reservation together with the reservation information; and
in response to pressing of the button, display on the display an input field for a resource name and an input field for a time slot.

11. The resource reservation system of claim 9, wherein
the second circuitry is further configured to when an input field for resource name is selected, display on the display, the resource reserved by the past reservation information including the user identification information in one of the reservation-making user and the participant in a selectable manner.

12. A usage management method of managing usage of resources, the method comprising:
acquiring resource identification information for each resource that is accessible; and
requesting an information processing apparatus that manages reservation of resource, to use the resource identified by the acquired resource identification information.

13. A non-transitory recording medium storing a plurality of instructions which, when executed by one or more processors, causes the processors to perform a usage management method comprising:
acquiring resource identification information for each resource that is accessible; and
requesting an information processing apparatus that manages reservation of resource, to use the resource identified by the acquired resource identification information.
